(19) United States
(12) Patent Application Publication
(10) Pub. No.: US 2005/0129823 A1
(43) Pub. Date: Jun. 16, 2005

(54) Composition and method for making high-protein and low-carbohydrate food products

(76) Inventors: Christopher T. Dohl, Netawaka, KS (US); Jennifer A. Gaul, Effingham, KS (US); Gregory J. Stempien, Atchison, KS (US); Kyungsoo Woo, Shawnee, KS (US); Clodualdo C. Maningat, Platte City, MO (US); Sukh D. Bassi, Atchison, KS (US)

Correspondence Address: LATHROP & GAGE LC, 2345 GRAND AVENUE, SUITE 2800, KANSAS CITY, MO, 64108, US

(21) Appl. No.: 10/983,506

(22) Filed: Nov. 5, 2004

Related U.S. Application Data
(60) Provisional application No. 60/518,126, filed on Nov. 7, 2003.

(51) Int. Cl. A21D 10/00

(52) U.S. Cl. 426/549

(57) ABSTRACT

Conventional food compositions for use in making baked goods and extruded food products are improved by reducing the carbohydrate content. This is done by substituting the conventional flour in whole or in part by a combination of starch that is resistant to amylase digestion and/or from about 1-150 baker's percent of a first proteinaceous ingredient comprising at least about 70% by weight protein, and a second proteinaceous ingredient selected from the group consisting of (i) between about 0.5-100 baker's percent of a wheat protein isolate product; (ii), between about 0.5-100 baker's percent of a wheat protein concentrate product; (iii) between about 0.5-100 baker's percent of a devitalized wheat gluten product; (iv) between about 0.5-20 baker's percent of a fractionated wheat protein product; (v) between about 0.5-20 baker's percent of a deamidated wheat gluten product; (vi) between about 0.5-30 baker's percent of a hydrolyzed wheat protein product; and (vii) any combination of ingredients (i) to (vi).

### RELATED APPLICATION

This application claims benefit of priority to provisional application Ser. No. 60/518,126 filed Nov. 7, 2003, which is incorporated by reference to the same extent as though fully replicated herein.

### BACKGROUND

1. Field of the Invention

The present invention pertains to improved bakery products (particularly wheat-containing bakery products and doughs) having higher protein and lower carbohydrate contents when compared with similar, more traditional bakery products and doughs. Products may comprise a first protein source along with a second proteinaceous ingredient and, optionally, a quantity of resistant starch.

2. Description of the Related Art

The rise in popularity of high-protein diets has increased the demand for high-protein, and consequently, low carbohydrate substitutes for foods, particularly flour based products, which typically contain a significant amount of carbohydrate. Many attempts have been made to decrease the carbohydrate level in these products by substituting a protein source for flour in the product's formulation. While this approach has solved the problem of providing a high-protein, low-carbohydrate product, generally, the resulting product does not have the handling characteristics, loaf volume, crumb grain, texture, or flavor of a traditional flour product.

For example, if vital wheat gluten is used in large amounts in the production of bread dough, the dough will be too strong or bucky and difficult to handle during mixing, dividing, sheeting, and molding. Also, high levels of protein such as soy protein may adversely affect flavor and give unacceptable volume and crumb grain properties.

Therefore, there exists a real need in the art for a high-protein, low-carbohydrate food product which closely resembles a traditional flour based product. The new product should exhibit dough handling, mach inability, loaf volume, crumb grain, and flavor characteristics similar to those of a traditional flour product.

### SUMMARY OF THE INVENTION

The present invention overcomes the above problems and provides a high-protein, low carbohydrate food product which exhibits dough handling properties, loaf volume, crumb grain, and flavor characteristics similar to those of a traditional flour based food product. As used herein, the term “high protein, low-carbohydrate food product” refers to compositions which contain higher protein and lower carbohydrate amounts relative to more traditional-type flour based food products. The term “flour based food product” includes, but is not limited to leavened or unleavened, traditionally flour-based products such as bread (including sponge and dough bread), cakes, pretzels, muffins, doughnuts, brownies, cookies, pancakes, waffle, biscuits, rolls, crackers, pie crusts, pizza crusts, hamburger buns, pita bread, tortillas, pasta, cereal, corn curl, fruit crunch bars, and other snacks, etc.

In addition to comprising a quantity of flour (particularly wheat flour), preferred food products (including dough) contain from about 1-150 baker's percent of a first proteinaceous ingredient (preferably from about 5-60 baker's percent) comprising at least about 70% by weight protein and a second proteinaceous ingredient (preferably different from the first ingredient) selected from the group consisting of
(a) between about 0.5-100 baker's percent of a wheat protein isolate product;
(b) between about 0.5-100 baker's percent of a wheat protein concentrate product;
(c) between about 0.5-100 baker's percent of a devitalized wheat gluten product;
(d) between about 0.5-20 baker's percent of a fractionated wheat protein product;
(e) between about 0.5-20 baker's percent of a deamidated wheat gluten product;
(f) between about 0.5-30 baker's percent of a hydrolyzed wheat protein product; and
(g) any combination of ingredients (a)-(f).

As used herein, the term “baker's percentage” means the weight percent taken on a flour basis, with the weight of flour present in the product being 100%.

Furthermore, all protein weight percentages expressed herein are on a N×6.25, dry basis, unless otherwise specified.

Wheat protein isolates are generally derived from wheat gluten by taking advantage of gluten's solubility at alkaline or acidic pH values. Wheat gluten is soluble in aqueous solutions with an acidic or alkaline pH and exhibits a classical “U-shaped” solubility curve with a minimum solubility or isoelectric point at pH 6.5-7.0. By dissolving the gluten, proteins can be separated from non-protein components by processes like filtration, centrifugation, or membrane processing followed by spray drying. Alternatively, wet gluten from wet processing of wheat flour can be repeatedly kneaded, water washed, and dewatered to get rid of contaminating starch and other non-protein components, and subsequently flash dried. These techniques yield a wheat protein isolate product with elevated protein content, at least about 85% by weight, more preferably at least about 90% by weight (on an N×6.25, dry basis). Wheat protein isolates are less elastic but more extensible than wheat gluten. Examples of preferred wheat protein isolates include Arise™ 3000, Arise™ 5000, and Arise™ 6000 available from MGP Ingredients, Inc. of Atchison, Kans.

Wheat protein concentrates are proteinaceous compositions which preferably have protein contents of at least about 70% by weight, and preferably at least about 82% by weight (N×6.25, dry basis). Wheat protein concentrates may be of different varieties manufactured by a number of different methods. Vital wheat gluten is one type of wheat protein concentrate that has a protein content of at least about 82% by weight (N×6.25, dry basis). Vital wheat gluten is a viscoelastic protein manufactured by a flash drying method. Additional types of wheat protein concentrates are manufactured by dispersing wet gluten in an ammonia solution followed by spray drying. These wheat protein concentrates exhibit lesser viscoelastic properties than vital wheat gluten but tend to be more extensible. Examples of the latter type of wheat protein concentrates include FP 300™, FP™ 500, FP™ 600, and FP™ 800 available from MGP Ingredients.

Wheat gluten can be devitalized (or rendered non-vital) by the application of moisture, heat, pressure, shear, enzymes, and/or chemicals. Devitalized gluten is characterized by denaturation of proteins where structural changes occur and certain bonds are broken resulting in a product that is noncohesive and lacks viscoelasticity. Typical processing equipment used to carry out this devitalization includes extruders, jet-cookers, and drum-driers. For example, wheat gluten may undergo extrusion processing to produce a texturized product which does not exhibit the same viscoelastic properties of typical wheat gluten. In other words, the devitalized gluten does not form a rubbery and/or extensible dough when hydrated. Devitalized wheat gluten preferably comprises at least about 60% by weight protein, and more preferably at least about 70% by weight (N×6.25, dry basis). Examples of devitalized wheat gluten for use as described herein Wheatex™ 16, Wheatex™ 120, Wheatex™ 240, Wheatex™ 751, Wheatex™ 1501, Wheatex™ 2120, Wheatex™ 2240, Wheatex™ 2400, Wheatex™ 3000, Wheatex™ 6000, and Wheatex™ 6500 available from MGP Ingredients.

Wheat gluten is a binary mixture of gliadin and glutenin. These components can be separated by alcohol fractionation or by using a non-alcoholic process, for example, as disclosed in U.S. Pat. No. 5,610,277, employing the use of organic acids. Gliadin is soluble in 60-70% alcohol and comprises monomeric proteins with molecular weights ranging from 30,000 to 50,000 Daltons. These proteins are classified as alpha-, beta-, gamma-, and omega-gliadins depending on their mobility during electrophoresis at low pH. Gliadin is primarily responsible for the extensible properties of wheat gluten. Glutenin is the alcohol insoluble fraction and contributes primarily to the elastic or rubbery properties of wheat gluten. Glutenin is a polymeric protein stabilized with inter-chain disulfide bonds and made up of high-molecular weight and low molecular weight subunits. Generally, glutenin exhibits a molecular weight exceeding one million Daltons. Preferred fractionated wheat protein products comprise at least about 85% by weight protein, and more preferably at least about 90% by weight for gliadin and about 75% by weight protein, and more preferably at least about 80% by weight for glutenin, all proteins expressed on N×6.25, dry basis.

Deamidated wheat protein products maybe manufactured according to a number of techniques. One such technique is to treat wheat gluten with low concentrations of hydrochloric acid at elevated temperatures to deamidate or convert glutamine and asparagine amino acid residues in the protein into glutamic and aspartic acid, respectively. Other techniques include treating wheat gluten with an alkaline solution or with enzymes such as transglutaminase. This modification causes a shift in the isoelectric point of the protein from about neutral pH to about pH 4. This signifies that the deamidated wheat protein product is least soluble at pH 4, but is soluble at neutral pH. Deamidated wheat protein products preferably comprise at least about 75% by weight protein, and more preferably at least about 83% by weight (N×6.25, dry basis). An example of a deamidated wheat protein product for use as described herein is WPI 2100 available from MGP Ingredients.

Hydrolyzed wheat protein products are manufactured by reacting an aqueous dispersion of wheat gluten with food-grade proteases having endo- and/or exo-activities to hydrolyze the proteins into a mixture of low-molecular weight peptides and polypeptides. The hydrolyzed mixture is then dried. Hydrolyzed wheat protein products generally exhibit a water solubility of at least about 50%. Hydrolyzed wheat protein products preferably have protein contents of at least about 70% by weight, more preferably at least about 82% by weight (on an 6.25×N, dry basis). Examples of hydrolyzed wheat protein products for as described herein include HWG™ 2009, FP™ 1000, and FP™ 1000 Isolate, all available from MGP Ingredients.

Preferably, high-protein food products contain from about 1-150 baker's percent of the first proteinaceous ingredient, more preferably from about 5-60 baker's percent. Preferred first proteinaceous ingredients comprise at least about 70% by weight protein and more preferably at least 82% by weight protein (6.25×N, dry basis). Exemplary preferred first proteinaceous ingredients include vital wheat gluten, soy protein concentrate, soy protein isolate, whey protein, sodium caseinate, nonfat dry milk, dried egg whites, wheat protein isolate, wheat protein concentrate, devitalized wheat gluten, fractionated wheat protein, deamidated wheat gluten, hydrolyzed wheat protein, and mixtures thereof.

Food products according to these instrumentalities may be chemically leavened or yeast leavened. Preferred chemical leavening agents include sodium bicarbonate, monocalcium phosphate, sodium aluminum phosphate, sodium aluminum sulfate, sodium acid pyrophosphate, dicalcium phosphate, potassium acid tartrate, and glucono-delta-lactone.

Preferred yeast-leavened products and dough have a total protein content from about 5-35% by weight, and more preferably from about 20-28% by weight. Preferred chemically leavened products and dough have a total protein content from about 4-18% by weight, more preferably from about 6-12% by weight.

Preferably, the products contain an amount of resistant starch. The resistant starch may be used in place of at least a portion of the flour which comprises traditional flour products, thereby effectively reducing the net carbohydrate total of the traditional product. As explained in further detail below, resistant starch is generally not digestible thereby exhibiting characteristics which are similar to those of dietary fiber.

In 1987 Englyst and Cummings at the MRC Dunn Clinical Nutrition Center in Cambridge, UK, proposed a classification of starch based on its likely digestive properties in vivo. They also devised in vitro assay methods to mimic the various digestive properties of starch. Three classes of dietary starch were proposed:

(1) Rapidly Digestible Starch (RDS). RDS is likely to be rapidly digested in the human small intestine; examples include freshly cooked rice and potato, and some instant breakfast cereals.

(2) Slowly Digestible Starch (SDS). SDS is likely to be slowly yet completely digested in the small intestine; examples include raw cereal starch and cooked pasta.

(3) Resistant Starch (RS). RS is likely to resist digestion in the small intestine. RS is thus defined as the sum of starch and starch degradation products not likely to be absorbed in the small intestine of healthy individuals. RS can be subdivided into four categories depending on the cause of resistance (Englyst et al., Eur. J. Clin. Nutr. 46(suppl 2):S33, 1992; Eerlingen et al., Cereal Chem. 70:339, 1993). RS may take the following forms:
RS₁. Physically inaccessible starch due to entrapment of granules within a protein matrix or within a plant cell wall, such as in partially milled grain or legumes after cooling.
RS₂. Raw starch granules, such as those from potato or green banana, that resist digestion by alpha-amylase, possibly because those granules lack micropores through their surface.
RS₃. Retrograded amylose formed by heat/moisture treatment of starch or starch foods, such as occurs in cooked/cooled potato and corn flake.
RS₄. Chemically modified starches, such as acetylated, hydroxypropylated, or cross-linked starches that resist digestion by alpha-amylase. Those modified starches would be detected by the in vitro assay of RS. However, some RS₄ may not be fermented in the colon.

RS₁, RS₂, RS₃ are physically modified forms of starch and become accessible to alpha-amylase digestion upon solubilization in sodium hydroxide or dimethyl sulfoxide. RS₄ that is chemically substituted remains resistant to alpha-amylase digestion even if dissolved. RS₄ produced by crosslinking would resist dissolution.

Highly cross-linked wheat starches belonging to RS₄ category may be manufactured, for example, by processes disclosed in U.S. Pat. No. 5,855,946 and U.S. Pat. No. 6,299,907. Typical total dietary fiber content (AOAC Method 991.43) of these RS₄ products can range from 10% to greater than 70%. Examples of preferred RS₄ products for as described herein are the FiberStar™ series, for example FiberStar™ 70, available from MGP Ingredients.

Preferred products contain from about 5-120 baker's percent of a resistant starch, and more preferably from about 20-90 baker's percent.

Table 1 summarizes broad and preferred ranges of the various second proteinaceous ingredients for use in products as described herein. The various weight percentages listed are on a flour weight basis (or baker's percent).

TABLE 1
RANGES OF VARIOUS SECOND PROTEINACEOUS INGREDIENTS
(BAKER'S PERCENT)

| | | Preferred |
|---|---|---|
| Second proteinaceous ingredient | Broad range | range |
| Wheat protein isolate product | 0.5-100% | 5-50% |
| Wheat protein concentrate product | 0.5-100% | 5-50% |
| Devitalized wheat gluten product | 0.5-100% | 5-25% |
| Fractionated wheat protein product | 0.5-20% | 0.5-5% |
| Deamidated wheat gluten product | 0.5-20% | 0.5-5% |
| Hydrolyzed wheat protein product | 0.5-30% | 0.5-5% |

It will be appreciated that the commercially available resistant starches have a significant dietary fiber content, for example as shown in Table 2.

TABLE 2
Total Dietary Fiber (TDF) Content of
Commercial Resistant Starches

| Resistant Starch | TDF % |
|---|---|
| Novelose ™ 260¹ | 50.5% |
| Hi-Maize ™¹ | 49.0% |
| Novelose ™ 240¹ | 32.8% |
| Novelose ™ 330¹ | 32.7% |
| CrystaLean ™² | 33.5% |
| FiberStar ™ 70³ | 75.6% |

¹National Starch & Chemical Company, Bridgewater New Jersey.
²Opta Food Ingredients, Inc., Bedford Massachusetts.
³MGP Ingredients, Atchinson, Kansas.

Preferred products exhibit several nutritional and functional benefits. The products are a good source of nutrition due to their elevated protein content and because of a reduced total caloric contribution from carbohydrates. The various protein sources provide a good complement of amino acids. In addition to being an excellent source of fiber (attributable to the presence of resistant starch), the products exhibit a low glycemic index. As stated previously, the inventive formulation improves dough handling and machinability, decreases dough buckiness, and improves product flavor.

### DETAILED DESCRIPTION

Various nonlimiting embodiments according to preferred materials and methods are set forth in the Examples that follow. These examples demonstrate a principle of improving various food products that contain conventional wheat flour. Improvement is made by virtue of substituting a portion of the conventional wheat flour with an amylase resistant starch in combination with a material selected from the group consisting of a wheat protein isolate a wheat protein concentrate, a devitalized wheat gluten product; a fractionated wheat protein; a deamidated wheat gluten, a hydrolyzed wheat protein product, and combinations thereof, in effective amounts to reduce the available carbohydrate content and increase the dietary fiber content of the bread product without deleteriously affecting the organoleptic qualities of the bread composition. Appreciable reductions in the carbohydrate content are, for example, reductions of at least 5%, 10%, 20%, 30%, 40% 50%, 60%, 70%, 80% or more by weight of the conventional carbohydrate content, when the carbohydrate content is defined as not including the amylase resistant carbohydrate. Similarly, appreciable increases in the dietary fiber content are, for example, increases of at least 5%, 10%, 20%, 30%, 40% 50%, 60%, 70%, 80% or more by weight of the conventional fiber content.

### Example 1

### Low Carbohydrate White Bread

This example shows a bread composition that is improved by substitution to have a resultant flour content may be defined as including about 33% by weight white bread flour, 20% vital wheat gluten, 23% amylase resistant starch, 12% wheat protein isolate, and 13% soy fiber.

| | | | Baker's |
|---|---|---|---|
| ESHA Code | Ingredient | | Percent |
| 38032 | White Bread Flour | Percentages use these | 32.69 |
| | Vital Wheat Gluten | amounts as 100% flour | 19.61 |
| | FiberStar ™ 70 | to determine the | 22.87 |
| | Arise ™ 5000 | Baker's Percent | 11.76 |
| 30023 | Soy Fiber | | 13.07 |

| | | |
|---|---|---|
| 28022 | Compressed Yeast | 12.0 |
| 26014 | Salt | 1.90 |
| 20041 | Water (Variable) | 76.0 |
| 8281 | Vegetable Oil | 6.0 |
| 31180 | Sucralose | 0.008 |
| 31003 | Calcium Propionate | 0.25 |
| 8291 | Diacetyltartaric Acid Esters of Monoglycerides | 0.25 |
| 8770 | Ethoxylated Mono-Diglycerides | 0.35 |
| 8288 | Sodium Stearoyl Lactylate | 0.25 |
| 32026 | Ascorbic Acid | 0.015 |
| 25035 | Sucrose | 0.75 |

The foregoing ingredients were mixed according to the following produces using a twelve speed Sunbeam mixmaster and a large mixing bowl:
1. Mix 1 for minute at low speed, the mix for 5 minutes high speed;
2. Dough temperature was 76° F., and the pan dough scaling factor was: 2.00;
3. Proof 1 for hour at 112/108° F.;
4. Bake for 24 minutes at 410° F.

The resultant product had 4 grams of net carbohydrate per 1 ounce slice.

Table 3 below provides a dietary fiber analysis of variations on the above bread formulation where 9% of the conventional flour has been replaced with a commercially available resistant starch.

TABLE 3
Total Dietary Fiber (TDF) Content of Breads
(9% of the Flour Replaced with Resistant Starch)

| Flour Substitute | TDF % |
|---|---|
| Control (No Substitute; Commercial Wheat Flour) | 5.2% |
| FiberStar ™ 70 | 6.6% |
| Hi-Maize ™ 1043 | 6.4% |
| CrystaLean ™ | 6.2% |
| Novelose ™ 260 | 6.1% |
| Novelose ™ 330 | 6.1% |
| Novelose ™ 240 | 5.8% |

### EXAMPLE 2

### Low Carbohydrate Bagel

This example shows a bagel composition that is improved by substitution to have a resultant flour content may be defined as including about 20% by weight white bread flour, 30% vital wheat gluten, 20% amylase resistant starch, 10% wheat protein isolate, and 10% soy fiber.

| | | | Baker's |
|---|---|---|---|
| ESHA Code | Ingredient | | Percent |
| 38040 | Whole Wheat Flour | Percentages use these | 30.00 |
| | Vital Wheat Gluten | amounts as 100% flour to | 30.00 |
| | FiberStar ™ 70 | determine the Baker's | 20.00 |
| | Arise ™ 5000 | Percent | 10.00 |
| 30023 | Soy Fiber | | 10.00 |

| | | |
|---|---|---|
| 28027 | Compressed Yeast | 2.00 |
| 26014 | Salt | 2.00 |
| 20041 | Water | 67.0 |
| 8281 | Vegetable Oil | 2.00 |
| 31003 | Calcium Propionate | 0.50 |

The foregoing ingredients were mixed according to the following procedures using a twelve speed Sunbeam mixmaster and a large mixing bowl:
1. Mix 1 minutes low speed
2. Mix 5 minutes high speed
3. Proof and bake as normal bagels

The resultant product was a 2.5 ounce bagel having 10 g net carbohydrates.

### EXAMPLE 3

### Low Carbohydrate Flour Tortilla

This example shows a bread composition that is improved by substitution to have a resultant flour content may be defined as including about 15% by weight white tortilla flour, 15% vital wheat gluten, 65% amylase resistant starch, and 5% wheat protein isolate.

| | | | Baker's |
|---|---|---|---|
| ESHA Code | Ingredient | | Percent |
| 38271 | White Tortilla Flour | Percentages use these | 15.00 |
| | Vital Wheat Gluten | amounts as 100% flour to | 15.00 |
| | FiberStar ™ 70 | determine the Baker's | 65.00 |
| | Arise ™ 5000 | Percent | 5.00 |

| | | |
|---|---|---|
| 28045 | Double Acting Baking Powder | 1.50 |
| 31003 | Calcium Propionate | 0.25 |
| 26014 | Salt | 1.75 |
| 8288 | Sodium Stearoyl Lactylate | 0.50 |
| 31060 | Coated Fumaric Acid | 0.35 |
| 8281 | Vegetable Oil | 10.00 |
| 20041 | Water | 55.00 |

The foregoing ingredients were processed like a normal tortilla. The leavening and emulsion systems in this formula are not critical. Any system may be substituted. The first four ingredients comprise the “Flour,” and are preferred for carbohydrate reduction. The “Flour” works well with any balanced tortilla formulation. The absorption is typically higher than a normal tortilla formulation. Sugar may be added sugar at 0.25%, or sucralose at 7 ppm to help mask flavors. The product was formed as a six inch tortilla. One ounce contained 4 g net carbohydrates.

The notation in the foregoing example shows a 65% by weight content (flour basis, also known as baker's percent) of FiberStar™ 70, such that the addition of normal flour including white tortilla flour and vital wheat gluten are present in equal amounts of 15% each, with 5% Arise™ 5000. Additional formulations were provided by reducing the FiberStar™ 70 content and compensating the reduction by increased equal amounts of white tortilla flour and vital wheat gluten. The additional formulations were analyzed for dietary fiber content, as reported in Table 4.

TABLE 4
Total Dietary Fiber (TDF) Content of
Flour Tortilla Containing FiberStar ™ 70

| Baker's percent of FiberStar ^{™} 70 | TDF % |
|---|---|
| Control (No FiberStar ™ 70) | 4.8% |
| 12.5% FiberStar ™ 70 | 10.9% |
| 25.0% FiberStar ™ 70 | 14.6% |

### EXAMPLE 4

### Low Carbohydrate Angel Food Cake

A conventional angel food cake formulation was improved by replacing the conventional cake flour with resistant starch and wheat gluten, as described below. The resultant a resultant flour content may be defined as including a mixture of the resistant starch and gluten.

| | | Weight For | | True | Weight for |
|---|---|---|---|---|---|
| | | 1 kg Batch | Baker's | Weight | 750 g Batch |
| | Ingredients | In Grams | Percent | % | In Grams |
| 1) | Sucrose | 234 | 186.31 | 23.4 | 175.5 |
| | Cream of Tartar | 6.3 | 5.02 | 0.63 | 4.725 |
| | Salt | 6.3 | 5.02 | 0.63 | 4.725 |
| | Sodium | 1.1 | 0.88 | 0.11 | 0.825 |
| | Propionate | | | | |
| | Powdered Egg | 53.9 | 42.91 | 5.39 | 40.425 |
| | Whites | | | | |
| 2) | Fructose | 22.3 | 22.3 | 2.23 | 16.725 |
| | Cold Water | 384.5 | 38.45 | 38.45 | 288.375 |
| 3) | Vanilla | 2.1 | 1.67 | 0.21 | 1.575 |
| 4) | Cake Flour* | 125.6 | 100 | 12.56 | 94.2 |
| | Midsol ™ 50 | 42 | 33.44 | 4.2 | 15.75 |
| | Wheat Starch | | | | |
| | Sucrose | 121.9 | 97.05 | 12.19 | 91.425 |
| | Total | 1000 | 533.05 | 100 | 734.25 |

*FiberStar ™/gluten blend (88:12 ratio) replaced cake flour in above formulation.

The foregoing ingredients were mixed according to the following procedure using a twelve speed Sunbeam mixmaster and a large mixing bowl:
1) Thoroughly dry-blend step 1) ingredients in 1^{st} speed;
2) Add step 2) and 3) liquids and whip in speed 6 until desired specific gravity for control is obtained, then mix to same time as control as with WPI samples;
3) Blend step 4) ingredients together well, then add and incorporate into mixture in slow speed for 30 seconds;
4) Scale as desired and bake as required.@ 375° F.

### EXAMPLE 5

### Low Carbohydrate White Cake Mix

A conventional white cake formulation was improved by replacing the conventional cake flour with resistant starch and wheat gluten, as described below. The resultant a resultant flour content may be defined as including a mixture of the amylase resistant starch and gluten.

| | | Baker's | Weight, |
|---|---|---|---|
| | Ingredient | Percent | Grams |
| 1) | Sugar | 27.18 | 540 |
| | P-46 | 0.50 | 10 |
| | MS-50 | 0.50 | 10 |
| | Cake Flour* | 24.16 | 480 |
| | Emulsifier** | 4.03 | 80 |
| | All Purpose Shortening | 5.54 | 110 |
| | Nonfat Dry Milk | 1.44 | 28.6 |
| | Modified Citrus Pectin | 0.05 | 1 |
| | Sodium Aluminum Phosphate | 0.40 | 8 |
| | Soda | 0.40 | 8 |
| | Salt | 0.60 | 12 |
| | Flavor*** | 0.25 | 5 |
| | Powdered Egg Whites | 0.86 | 17 |
| | Powdered Eggs | 2.11 | 42 |
| | | | 1351.6 |
| 2) | HSO | 14.09 | 280 |
| 3) | Water | 17.87 | 355 |
| | Total | | 3338.2 |

*FiberStar ™/gluten blend (88:12 ratio) replaced cake flour in above formulation.
**CAPMUL ™ 25 USED
***B&V ™ FLAVOR USED

The foregoing ingredients were mixed according to the following procedure using a twelve speed Sunbeam mixmaster and a large mixing bowl:
1) The ingredients were combined and stirred;
2) Mix for one minute using first speed then 2 minutes using second speed, then for one minute using first speed;
3) The bowl was scraped and mixing continued for two minutes at first speed.

The dough was scaled to 400 g sections and baked @ 350° F. for 24-25 minutes.

### EXAMPLE 6

### Comparative Pancakes or Waffles

A conventional pancake or waffle formulation “A” was improved by replacing the conventional cake flour with resistant starch and wheat gluten to form formulation “B,” as described below. The resultant flour content may be defined as including a mixture of the amylase resistant starch and gluten.

A. Normal Flour

| Ingredient | Total Weight % | Grams |
|---|---|---|
| Bread Flour | 17.3 | 173 |
| Pastry Flour | 50.4 | 504 |
| Sugar | 12.5 | 125 |
| Salt | 1.5 | 15 |
| Baking Powder | 2.2 | 22 |
| Nonfat Dry Milk | 9 | 90 |
| Shortening | 6.6 | 66 |
| Butter-Vanilla Flavor | 0.5 | 5 |
| Total | 100 | 500 |
| add the following: | | |
| Water | 70-72 | 350-360 |
| Eggs | 35 | 175 |
| Oil | 10 | 50 |

mix above and process for pancakes or waffles

B. Low Carbohydrate Formula

| Ingredient | Total Weight % | Grams |
|---|---|---|
| Fiberblend* | 67.7 | 677 |
| Sugar | 12.5 | 125 |
| Salt | 1.5 | 15 |
| Baking Powder | 2.2 | 22 |
| Nonfat Dry Milk | 9 | 90 |
| shortening | 6.6 | 66 |
| butter-vanilla flavor | 0.5 | 5 |
| Total For 500 g mix | 100 | 500 |
| add the following: | | |
| water | 70-72 | 350-360 |
| eggs | 35 | 175 |
| oil | 10 | 50 |

mix above and process for pancakes or waffles
*Fiberblend is 12 parts vital wheat gluten and 88 parts FiberStar ™ 70

The two formulations A and B produced pancakes and waffles having similar organoleptic qualities.

### EXAMPLE 7

### Low Carbohydrate Muffin Formula

A conventional muffin formulation was improved by replacing the conventional cake flour with resistant starch and wheat gluten, as described below. The resultant a resultant flour content may be defined as including a mixture of the amylase resistant starch and gluten.

| | | Baker's | Weight in |
|---|---|---|---|
| | Ingredient | Percent | Grams |
| 1) | Cake Flour* | 80 | 400 |
| | Bread flour* | 20 | 100 |
| | Vital Wheat Gluten | 1 | 5 |
| | Nonfat Dry Milk | 10 | 50 |
| | Sucrose | 110 | 550 |
| | Cake Shortening | 15 | 75 |
| | Salt | 1.9 | 9.5 |
| | Soda | 1.75 | 8.75 |
| | Sodium Aluminum Phosphate | 1.5 | 7.5 |
| | SAPP28 | | |
| | Modified Citrus Pectin | 0.3 | 1.5 |
| | Baking Powder | 0.3 | 1.5 |
| | P-40 | 5 | 25 |
| | Flavor | 1 | 5 |
| | Color | (Desired | |
| | | Amount) | |
| | Guar | 0.4 | 2 |
| | Sodium Stearoyl Lactylate | 0.5 | 2.5 |
| | Powdered Egg Whites or | 22 | 110 |
| | Powdered Eggs | | |
| | Total | 100% | 1200 |
| 2) | Water | 24% | 288 |
| | Oil | 20% | 240 |
| 3) | Water | 22% | 264 |

*FiberStar ™-gluten blend (88:12 ratio) replaced cake/bread flour in formula

The foregoing ingredients were mixed according to the following procedure using a twelve speed Sunbeam mixmaster and a large mixing bowl:
1) The ingredients 1) were combined with the ingredients 2) and mixed for on minute using first speed, then two minutes using second speed;
2) The ingredients 3) were added and mixed for one minute using first speed.

### EXAMPLE 8

### Low Carbohydrate Fruity Crunch Bar

A conventional fruity crunch bar formulation was improved by replacing the conventional cake flour with resistant starch and wheat gluten, as described below. The resultant a resultant flour content may be defined as including a mixture of the amylase resistant starch and gluten.

| Ingredients | Total Weight % |
|---|---|
| FiberStar ™ 70 | 15.11 |
| HWG ™ 2009 | 3.36 |
| Almond Flour | 11.75 |
| Soy Protein Crisp | 11.01 |
| Chopped Almonds | 5.04 |
| Soy Nuts | 5.04 |
| Dried Fruit | 8.39 |
| Maltisweet B¹ | 37.28 |
| Artificial Flavor | 1.00 |
| White Sugar Free Coating² | 2.02 |

¹Maltitol Solution from SPI Polyols, New Castle, DE.
²Galaxy White Sugar Free Coating Nuggets from Wilbur Chocolate, Lititz, PA.

The foregoing ingredients were mixed according to the following procedure using a twelve speed Sunbeam mixmaster and a large mixing bowl:
1) Blend all dry ingredients together.
2) Over high heat boil the Maltisweet for two minutes;
3) Pour over blended dry ingredients and mix together
4) Roll mixed ingredients to desired thickness;
5) Dip or spread the melted white sugar free coating over the rolled bar;
6) Let cool and dry.

### EXAMPLE 9

### Low Carbohydrate Cookie

A conventional cookie formulation was improved by replacing the conventional cake flour with resistant starch, hydrolyzed wheat protein, and wheat gluten, as described below. The resultant a resultant flour content may be defined as including a mixture of the amylase resistant starch and gluten.

| | Ingredients | Total Weight % |
|---|---|---|
| 1) | FiberStar ™ 70 | 25.01 |
| | Vital Wheat Gluten | 4.55 |
| | Arise ™ 5000 | 3.23 |
| | Midsol ™ 46 | 3.41 |
| | Artificial Flavor¹ | 0.51 |
| | Sodium Bicarbonate | 0.49 |
| | Salt | 0.34 |
| | Xanthan Gum | 0.23 |
| | Acesulfame K | 0.02 |
| | Sucralose | 0.01 |
| 2) | Butter Salted | 25.81 |
| | Isomalt ST/F² | 18.19 |
| 3) | Liquid Whole Egg | 10.12 |
| | Maltisweet 3145³ | 6.71 |
| | Pure Vanilla Extract | 1.36 |

¹Artificial Brown Sugar Flavor. Mother Murphy's.
²Isomalt ST/F is an artificial sweetener from Isomalt, Morris Plains, NJ.
³Maltitol Solution from SPI Polyols, New Castle, DE.

The foregoing ingredients were mixed according to the following procedure using a twelve speed Sunbeam mixmaster and a large mixing bowl:
1) Blend all ingredients 1) together;
2) In separate bowl cream ingredients 2) (Butter and Isomalt) using a Kitchen Aid—5 quart bowl;
3) Add ingredients 3) to creamed mixture and mix until blended;
4) Slowly add the ingredients 1) to blended ingredients 2) and 3). Mix until all ingredients are blended together.
5) Scale dough into 30-33 g balls.
6) Bake at 375° F. for 13 minutes.

### EXAMPLE 10

### Low Carbohydrate Brownie

A conventional brownie formulation was improved by replacing the conventional cake flour with resistant starch, hydrolyzed wheat protein, and wheat gluten, as described below. The resultant a resultant flour content may be defined as including a mixture of the amylase resistant starch, wheat protein isolate, and wheat gluten.

| | Ingredients | Total Weight % |
|---|---|---|
| 1) | FiberStar ™ 70 | 44.96 |
| | Flax Flour | 5.00 |
| | Vital Wheat Gluten | 3.50 |
| | Arise ™ 5000 | 1.00 |
| | Cocoa Powder | 5.99 |
| | Jet Black Cocoa | 0.90 |
| | Sodium Bicarbonate | 0.41 |
| | Asesulfame K-Sweetener | .025 |
| | Sucralose | .020 |
| | Chocolate Flavor¹ | 0.35 |
| | Chocolate Flavor² | 0.31 |
| | Sodium Propionate | 0.17 |
| | Salt | 0.70 |
| | Dark Chocolate Pieces³ | 5.99 |
| | Xanthan Gum | 1.00 |
| 2) | Liquid Whole Egg | 9.99 |
| | Maltisweet 3145⁴ | 9.09 |
| | Pure Vanilla Extract | 1.32 |
| | Vegetable Oil | 9.27 |
| | Total | 100 |
| 3) | Water | 52% of mix weight |

¹Art. Chocolate Fudge Flavor. Mother Murphy's.
²Art. N&A Cocoa Enhancer. Mother Murphy's.
³Mercury Sugar Free Dark Chocolate Nuggets from Wilbur Chocolate Co. Lititz, Pennsylvania.
⁴Maltitol Solution is Maltisweet 3145 from SPI Polyols, New Castle, Delaware.

The foregoing ingredients were mixed according to the following procedure using a twelve speed Sunbeam mixmaster and a large mixing bowl:
1) Mix ingredients 1) together until well blended;
2) In a separate bowl mix ingredients 2) together;
3) Combine ingredients 1 into ingredients 2;
4) Mix until well blended, approx. 2 minutes on low speed;
5) Bake at 375° F. for 22 minutes;
6) Scale weight: 700 g, in a 9×9 pan.

### EXAMPLE 11

### Low Carbohydrate Snack Pellet Formulations (For Use in an Indirect Expanded Snack)

A conventional snack pellet formulation was improved by replacing the conventional cake flour with resistant starch, hydrolyzed wheat protein, and wheat gluten, as described below. The resultant a resultant flour content may be defined as including an amount of amylase resistant starch that ranges from 10% to 25% by weight of the composition.

| | Formula 1, | Formula 2, | Formula 3 | Formula 4, |
|---|---|---|---|---|
| | Total Weight | Total Weight | Total Weight | Weight |
| Ingredients | % | % | % | % |
| Tapioca starch | 30 | 18 | 6 | 0 |
| FiberStar ™ 70 | 0 | 12 | 24 | 12 |
| Midsol ™ 1 | 0 | 0 | 0 | 18 |
| Wheat flour | 58 | 58 | 58 | 58 |
| Corn flour | 10 | 10 | 10 | 10 |
| Monoglyceride | 0.5 | 0.5 | 0.5 | 0.5 |
| Salt | 1 | 1 | 1 | 1 |
| Sodium | 0.5 | 0.5 | 0.5 | 0.5 |
| bicarbonate | | | | |

### EXAMPLE 12

### Low Carbohydrate Extruded Breakfast Cereal Formulations (Fruit Loop Multi-Grain Product)

A conventional extruded breakfast cereal formulation was improved by replacing the conventional cake flour with resistant starch, hydrolyzed wheat protein, and wheat gluten, as described below. The resultant a resultant flour content may be defined as including an amount of amylase resistant starch that ranges from 10% to 30% by weight of the composition.

| | Formula 1, | Formula 2, | Formula 3, | Formula 4, | Formula 5, | Formula 6, | Formula 7, |
|---|---|---|---|---|---|---|---|
| | Total Weight | Total Weight | Total Weight | Total Weight | Total Weight | Total Weight | Total Weight |
| Ingredients | % | % | % | % | % | % | % |
| Wheat flour | 30 | 18 | 6 | 26 | 22 | 16 | 2 |
| FiberStar ™ 70 | 0 | 12 | 24 | 12 | 24 | 0 | 0 |
| High-amylose maize | 0 | 0 | 0 | 0 | 0 | 14 | 28 |
| Corn flour | 42 | 42 | 42 | 38 | 34 | 42 | 42 |
| Oat flour | 20 | 20 | 20 | 16 | 12 | 20 | 20 |
| Sugar | 6 | 6 | 6 | 6 | 6 | 6 | 6 |
| Salt | 2 | 2 | 2 | 2 | 2 | 2 | 2 |

### EXAMPLE 13

### Corn Curl Formulations (For Use in a Direct Expanded Snack)

A conventional corn curl formulation was improved by replacing the conventional cake flour with resistant starch, hydrolyzed wheat protein, and wheat gluten, as described below. The resultant a resultant flour content may be defined as including an amount of amylase resistant starch that ranges from 25% to 75% by weight of the composition.

| | Formula | Formula | Formula | Formula | Formula | Formula |
|---|---|---|---|---|---|---|
| | 1, Total | 2, Total | 3, Total | 4, Total | 5, Total | 6, Total |
| | Weight | Weight | Weight | Weight | Weight | Weight |
| Ingredients | % | % | % | % | % | % |
| Corn meal | 100 | 75 | 50 | 25 | 88 | 64 |
| FiberStar ™ 70 | 0 | 25 | 50 | 75 | 12 | 36 |

### EXAMPLE 14

### Low Carbohydrate Dietary Fiber in Muffin Formulations

A conventional muffin formulation was improved by replacing the conventional cake flour with resistant starch, hydrolyzed wheat protein, and wheat gluten, as described below. The resultant a resultant flour content may be defined as including a 15% by weight replacement amount of resistant starch to raise the dietary fiber by an incremental amount ranging from 1%-3% by weight.

A conventional muffin formulation using cake flour and bread flour is shown below.

| Ingredient | Baker's Percent |
|---|---|
| Cake flour | 80 |
| Bread flour | 20 |
| Nonfat dry milk | 10 |
| Sucrose | 110 |
| Cake shortening | 15 |
| Salt | 1.9 |
| Baking soda | 1.75 |
| Sodium Aluminum Phosphate | 1.5 |
| Modified Citrus Pectin | 0.3 |
| Baking powder | 0.3 |
| Pregel 40 | 4 |
| Flavor | 1 |
| Sodium Stearoyl Lactylate | 0.5 |
| Powdered egg | 24 |

Substitution was made to replace 15% of the cake flour and 15% of the bread flour in the above formulation with various types of resistant starch. The mixtures were subjected to TDF analysis, and Table 5 reports the results.

TABLE 5
Total Dietary Fiber (TDF) Content of Muffins
(15% of the Flour Replaced with Resistant Starch)

| Resistant Starch Used As Flour Replacement | TDF % |
|---|---|
| Control (No replacement) | 2.0% |
| FiberStar ™ 70 | 5.0% |
| Novelose ™ 260 | 4.4% |
| Hi-Maize ™ 1043 | 4.1% |
| Novelose ™ 330 | 3.8% |
| CrystaLean ™ | 3.8% |
| Novelose ™ 240 | 3.3% |

### EXAMPLE 15

### Low Carbohydrate Snack Cracker Formula

A conventional cracker formulation using cake flour and bread flour is shown below.

| Ingredients | Baker's Percent |
|---|---|
| Flour, cookie (F-1) | 100.0 |
| Shortening, all-purpose | 12.0 |
| Sugar, granulated | 8.0 |
| Malt, non-diastatic | 0.5 |
| Whey | 1.5 |
| Salt | 1.0 |
| Sodium bicarbonate | 0.5 |
| Yeast, fresh compressed | 0.25 |
| Water (90° F.) | 28.0 |
| *Ammonium bicarbonate | 1.0 |
| *Sodium sulfite | 0.04 |

*dissolve separately in water before adding.

The foregoing ingredients were subjected to TDF analysis, with various percentages of the flour being replaced with resistant starch. Table 6 reports the results. The resultant product has a formulation that may be defined as including a replacement amount of flour that contains from 1% to 35% of the conventional flour with an amylase resistant starch.

TABLE 6
Total Dietary Fiber (TDF) Content of Snack Crackers

| Ingredients | TDF % |
|---|---|
| Control (No replacement) | (Lab results not available) |
| 1.7% Arise ™ 5000 | 12.5% |
| 16.7% FiberStar ™ 70 | (Lab results not available) |
| 3.3% Arise ™ 5000 | 21.5% |
| 33.3% FiberStar ™ 70 | (Lab results not available) |

### EXAMPLE 16

### Low Carbohydrate Chocolate Chip Cookie Formulation

A conventional chocolate chip cookie recipe was improved by substituting the conventional flour content with FiberStar™ in an amount ranging from 25% to 100% by weight of the conventional flour, as shown in Examples 16-19. The resultant flour content may be defined as containing amylase resistant starch.

Tables 7A, B and C replicate the food labeling information as might appear on a commercially available package of chocolate chip cookies where the “All Purpose White Flour” of the prior art has been replaced 100% using FiberStar™ 70.

TABLE 7A
Chocolate Chip Cookie Ingredients

| | | | | |
|---|---|---|---|---|
| Total Weight: | 975.34 | g | (34.40 | oz-wt.) |
| Serving Size: | 30.00 | g | (1.06 | oz-wt.) |

| | |
|---|---|
| Serves: | 32.51 |
| Cost: | — |

| Amount for | | | | | | | |
|---|---|---|---|---|---|---|---|
| 32.5113 | | | Amount for | | | ESHA | % Total |
| servings | | Food Item | 1 serving | | Cost | Code | Weight |
| 318.38 | g | All Purpose White Flour | 9.79289 | g | — | 38030 | 32.64% |
| | | Enriched-Blchd* | | | | | |
| 4.33 | g | Baking Soda | 0.13318 | g | — | 28003 | 0.44% |
| 4.5 | g | Table Salt | 0.13841 | g | — | 26014 | 0.46% |
| 154.5 | g | Brown Sugar-Unpacked | 4.75219 | g | — | 25201 | 15.84% |
| 227 | g | Butter-Salted LOL | 6.98218 | g | — | 8791 | 23.27% |
| 4.33 | g | Pure Vanilla Extract | 0.13318 | g | — | 26087 | 0.44% |
| | | Flavor (Single Fold) VD | | | | | |
| 100 | g | Egg-Large-Bld-Each | 3.07585 | g | — | 19510 | 10.25% |
| 162.3 | g | Sucrose | 4.99211 | g | — | 25035 | 16.64% |

*100% of this ingredient was replaced with FiberStar ™ 70.

TABLE 7B
Chocolate Chip Cookie Nutrients Per Serving

| Nutrients per Serving | | | | | |
|---|---|---|---|---|---|
| Calories | 128.38 | | Fat - Total | 5.91 | g |
| Protein | 1.40 | g | Saturated Fat | 4.11 | g |
| Carbohydrates | 17.13 | g | Vitamin A RE | 45.07 | RE |
| Dietary Fiber | 0.26 | g | Vitamin C | 0 | mg |
| % Calories from fat | 42% | | % Calories from carbs | 54% | |

TABLE 7C
Chocolate Chip Cookie Nutrition
Nutrition Facts

| Serving Size (30 g) | |
|---|---|
| Servings Per Container | |
| Amount Per Serving | |
| Calories 130 | Calories from Fat 50 |
| | % Daily Value* |
| Total Fat 6 g | 9% |
| Saturated Fat 4 g | 21% |
| Cholesterol 30 mg | 9% |
| Sodium 140 mg | 6% |
| Total Carbohydrates 17 g | 6% |
| Dietary Fiber 0 g | 0% |
| Sugars 10 g | |
| Protein 1 g | |

| | | |
|---|---|---|
| Vitamin A 4% | * | Vitamin C 0% |
| Calcium 0% | * | Iron 4% |

*Percent Daily Values are based on a 2,000 calorie diet. Your daily
values may be higher or lower depending on your calorie needs.

| | | |
|---|---|---|
| Calories: | 2,000 | 2,500 |

| | | | | | |
|---|---|---|---|---|---|
| Total Fat | Less than | 65 | g | 80 | g |
| Saturated Fat | Less than | 20 | g | 25 | g |
| Cholesterol | Less than | 300 | mg | 300 | mg |
| Sodium | Less than | 2,400 | mg | 2,400 | mg |
| Total Carbohydrate | | 300 | g | 375 | g |
| Dietary Fiber | | 25 | g | 30% | |
| Calories per gram: | | | | | |

Fat 9 - Carbohydrate 4 - Protein 4

### EXAMPLE 17

### Low Carbohydrate Chocolate Chip Cookie Formulation

Tables 8A, B and C replicate the food labeling information as might appear on a commercially available package of chocolate chip cookies where the “All Purpose White Flour” of the prior art has been replaced 75% using FiberStar™70.

TABLE 8A
Chocolate Chip Cookie Ingredients

| | | | | |
|---|---|---|---|---|
| Total Weight: | 975.32 | g | (34.40 | oz-wt.) |
| Serving Size: | 30.00 | g | (1.06 | oz-wt.) |

| | |
|---|---|
| Serves: | 32.51 |

| Amount for | | | | | | | |
|---|---|---|---|---|---|---|---|
| 32.5107 | | | Amount for | | | ESHA | % Total |
| servings | | Food Item | 1 serving | | Cost | Code | Weight |
| 79.56 | g | All Purpose White Flour | 2.4472 | g | — | 38030 | 8.16% |
| | | Enriched-Blchd* | | | | | |
| 4.33 | g | Baking Soda | 0.133.9 | g | — | 28003 | 0.44% |
| 4.5 | g | Table Salt | 0.13842 | g | — | 26014 | 0.46% |
| 154.5 | g | Brown Sugar-Unpacked | 4.75229 | g | — | 25201 | 15.84% |
| 227 | g | Butter-Salted LOL | 6.98232 | g | — | 8791 | 23.27% |
| 4.33 | g | Pure Vanilla Extract | 0.13319 | g | — | 26087 | 0.44% |
| | | Flavor (Single Fold) VD | | | | | |
| 100 | g | Egg-Large-Bld-Each | 3.07591 | g | — | 19510 | 10.25% |
| 162.3 | g | Sucrose | 4.99221 | g | — | 25035 | 16.64% |
| 210.14 | g | FiberStar ™ 70 | 6.46372 | g | — | | 21.55% |
| 28.66 | g | Vital Wheat Gluten | 0.88156 | g | — | | 2.94% |

*75% of this ingredient replaced with FiberStar ™ 70.

TABLE 8B
Chocolate Chip Cookie Nutrients Per Serving

| | | | | | |
|---|---|---|---|---|---|
| Calories | 127.92 | | Fat - Total | 5.89 | g |
| Protein | 1.38 | g | Saturated Fat | 4.10 | g |
| Carbohydrates | 17.38 | g | Vitamin A RE | 45.24 | RE |
| Dietary Fiber | 4.60 | g | Vitamin C | 0 | mg |
| % Calories from fat | 41% | | % Calories from carbs | 54% | |

TABLE 8C
Chocolate Chip Cookie Nutrition
Nutrition Facts

| Serving Size (30 g) | |
|---|---|
| Servings Per Container | |
| Amount Per Serving | |
| Calories 130 | Calories from Fat 50 |
| | % Daily Value* |
| Total Fat 6 g | 9% |
| Saturated Fat 4 g | 21% |
| Cholesterol 30 mg | 9% |
| Sodium 140 mg | 6% |
| Total Carbohydrates 17 g | 6% |
| Dietary Fiber 5 g | 18% |
| Sugars 10 g | |
| Protein 1 g | |

| | | |
|---|---|---|
| Vitamin A 4% | * | Vitamin C 0% |
| Calcium 2% | * | Iron 2% |

*Percent Daily Values are based on a 2,000 calorie diet. Your daily
values may be higher or lower depending on your calorie needs.

| | | |
|---|---|---|
| Calories: | 2,000 | 2,500 |

| | | | | | |
|---|---|---|---|---|---|
| Total Fat | Less than | 65 | g | 80 | g |
| Saturated Fat | Less than | 20 | g | 25 | g |
| Cholesterol | Less than | 300 | mg | 300 | mg |
| Sodium | Less than | 2,400 | mg | 2,400 | mg |
| Total Carbohydrate | | 300 | g | 375 | g |
| Dietary Fiber | | 25 | g | 30% | |
| Calories per gram: | | | | | |

Fat 9 - Carbohydrate 4 - Protein 4

### EXAMPLE 18

### Low Carbohydrate Chocolate Chip Cookie Formulation

Tables 9A, B and C replicate the food labeling information as might appear on a commercially available package of chocolate chip cookies where the “All Purpose White Flour” of the prior art has been replaced 50% using FiberStar™ 70.

TABLE 9A
Chocolate Chip Cookie Ingredients

| | | | | |
|---|---|---|---|---|
| Total Weight: | 975.36 | g | (34.40 | oz-wt.) |
| Serving Size: | 30.00 | g | (1.06 | oz-wt.) |

| | |
|---|---|
| Serves: | 32.51 |

| Amount for | | | | | | | |
|---|---|---|---|---|---|---|---|
| 32.512 | | | Amount for | | | ESHA | % Total |
| servings | | Food Item | 1 serving | | Cost | Code | Weight |
| 159.2 | g | All Purpose White Flour | 4.89665 | g | — | 38030 | 16.32% |
| | | Enriched-Blchd | | | | | |
| 4.33 | g | Baking Soda | 0.13318 | g | — | 28003 | 0.44% |
| 4.5 | g | Table Salt | 0.13841 | g | — | 26014 | 0.46% |
| 154.5 | g | Brown Sugar-Unpacked | 4.75209 | g | — | 25201 | 15.84% |
| 227 | g | Butter-Salted LOL | 6.98204 | g | — | 8791 | 23.27% |
| 4.33 | g | Pure Vanilla Extract | 0.13318 | g | — | 26087 | 0.44% |
| | | Flavor (Single Fold) VD | | | | | |
| 100 | g | Egg-Large-Bld-Each | 3.07579 | g | — | 19510 | 10.25% |
| 162.3 | g | Sucrose | 4.992 | g | — | 25035 | 16.64% |
| 140.1 | g | FiberStar ™ 70 | 4.30918 | g | — | | 14.36% |
| 19.1 | g | Vital Wheat Gluten | 0.58748 | g | — | | 1.96% |

*50% of this ingredient was replaced with FiberStar ™ 70.

TABLE 9B
Chocolate Chip Cookie Nutrients Per Serving

| | | | | | |
|---|---|---|---|---|---|
| Calories | 128.07 | | Fat - Total | 5.89 | g |
| Protein | 1.38 | g | Saturated Fat | 4.10 | g |
| Carbohydrates | 17.30 | g | Vitamin A RE | 45.18 | RE |
| Dietary Fiber | 3.15 | g | Vitamin C | 0 | mg |
| % Calories from fat | 41% | | % Calories from carbs | 54% | |

TABLE 9C
Chocolate Chip Cookie Nutrition
Nutrition Facts

| Serving Size (30 g) | |
|---|---|
| Servings Per Container | |
| Amount Per Serving | |
| Calories 130 | Calories from Fat 50 |
| | %Daily Value* |
| Total Fat 6 g | 9% |
| Saturated Fat 4 g | 20% |
| Cholesterol 30 mg | 9% |
| Sodium 140 mg | 6% |
| Total Carbohydrates 17 g | 6% |
| Dietary Fiber 3 g | 13% |
| Sugars 10 g | |
| Protein 1 g | |

| | | |
|---|---|---|
| Vitamin A 4% | * | Vitamin C 0% |
| Calcium 2% | * | Iron 2% |

*Percent Daily Values are based on a 2,000 calorie diet. Your daily
values may be higher or lower depending on your calorie needs.

| | | |
|---|---|---|
| Calories: | 2,000 | 2,500 |

| | | | | | |
|---|---|---|---|---|---|
| Total Fat | Less than | 65 | g | 80 | g |
| Saturated Fat | Less than | 20 | g | 25 | g |
| Cholesterol | Less than | 300 | mg | 300 | mg |
| Sodium | Less than | 2,400 | mg | 2,400 | mg |
| Total Carbohydrate | | 300 | g | 375 | g |
| Dietary Fiber | | 25 | g | 30% | |
| Calories per gram: | | | | | |

Fat 9 - Carbohydrate 4 - Protein 4

### EXAMPLE 19

### Low Carbohydrate Chocolate Chip Cookie Formulation

Tables 10A, B and C replicate the food labeling information as might appear on a commercially available package of chocolate chip cookies where the “All Purpose White Flour” of the prior art has been replaced 25% using FiberStar™70.

TABLE 10A
Chocolate Chip Cookie Ingredients

| | | | | |
|---|---|---|---|---|
| Total Weight: | 975.36 | g | (34.40 | oz-wt.) |
| Serving Size: | 30.00 | g | (1.06 | oz-wt.) |

| | |
|---|---|
| Serves: | 32.51 |

| Amount for | | | | | | | |
|---|---|---|---|---|---|---|---|
| 32.512 | | | Amount for | | | ESHA | % Total |
| servings | | Food Item | 1 serving | | Cost | Code | Weight |
| 238.8 | g | All Purpose White Flour | 7.34498 | g | — | 38030 | 24.48% |
| | | Enriched-Blchd* | | | | | |
| 4.33 | g | Baking Soda | 0.13318 | g | — | 28003 | 0.44% |
| 4.5 | g | Table Salt | 0.13841 | g | — | 26014 | 0.46% |
| 154.5 | g | Brown Sugar-Unpacked | 4.75209 | g | — | 25201 | 15.84% |
| 227 | g | Butter-Salted LOL | 6.98204 | g | — | 8791 | 23.275 |
| 4.33 | g | Pure Vanilla Extract | 0.13318 | g | — | 26087 | 0.44% |
| | | Flavor (Single Fold) VD | | | | | |
| 100 | g | Egg-Large-Bld-Each | 3.07579 | g | — | 19510 | 10.25% |
| 162.3 | g | Sucrose | 4.992 | g | — | 25035 | 16.64% |
| 70.05 | g | FiberStar ™ 70 | 2.15459 | g | — | | 7.18% |
| 9.55 | g | Vital Wheat Gluten | 0.29374 | g | — | | 0.98% |

*25% of this ingredient was replaced with FiberStar ™ 70.

TABLE 10B
Chocolate Chip Cookie Nutrients Per Serving

| | | | | | |
|---|---|---|---|---|---|
| Calories | 128.22 | | Fat - Total | 5.89 | g |
| Protein | 1.39 | g | Saturated Fat | 4.10 | g |
| Carbohydrates | 17.21 | g | Vitamin A RE | 45.12 | RE |
| Dietary Fiber | 1.71 | g | Vitamin C | 0 | mg |
| % Calories from fat | 42% | | % Calories from carbs | 54% | |

TABLE 10C
Chocolate Chip Cookie Nutrition
Nutrition Facts

| Serving Size (30 g) | |
|---|---|
| Servings Per Container | |
| Amount Per Serving | |
| Calories 130 | Calories from Fat 50 |
| | % Daily Value* |
| Total Fat 6 g | 9% |
| Saturated Fat 4 g | 21% |
| Cholesterol 30 mg | 9% |
| Sodium 140 mg | 6% |
| Total Carbohydrates 17 g | 6% |
| Dietary Fiber 2 g | 7% |
| Sugars 10 g | |
| Protein 1 g | |

| | | |
|---|---|---|
| Vitamin A 4% | * | Vitamin C 0% |
| Calcium 0% | * | Iron 2% |

*Percent Daily Values are based on a 2,000 calorie diet. Your daily
values may be higher or lower depending on your calorie needs.

| | | |
|---|---|---|
| Calories: | 2,000 | 2,500 |

| | | | | | |
|---|---|---|---|---|---|
| Total Fat | Less than | 65 | g | 80 | g |
| Saturated Fat | Less than | 20 | g | 25 | g |
| Cholesterol | Less than | 300 | mg | 300 | mg |
| Sodium | Less than | 2,400 | mg | 2,400 | mg |
| Total Carbohydrate | | 300 | g | 375 | g |
| Dietary Fiber | | 25 | g | 30% | |
| Calories per gram: | | | | | |

Fat 9 - Carbohydrate 4 - Protein 4

### EXAMPLE 20

### Low Carbohydrate Muffin Formulation

A conventional muffin recipe was improved by substituting the conventional flour content with FiberStar™ in an amount ranging from 25% to 100% by weight of the conventional flour, as shown in Examples 20-22. The resultant flour content may be defined as containing amylase resistant starch.

A muffin formulation was prepared in which 25% of the conventional flour was replaced using a resistant starch, FiberStar™70.

| Ingredients | Total Weight % |
|---|---|
| FiberStar ™ 70 | 4.87 |
| Vital Wheat Gluten | .88 |
| Cake flour | 13.29 |
| Bread flour | 3.32 |
| Nonfat Dry Milk | 2.22 |
| Sucrose | 24.37 |
| Salt | .42 |
| Cake shortening¹ | 3.32 |
| Soda | .39 |
| Sodium Aluminum Phosphate² | .33 |
| Modified Citrus Pectin² | .07 |
| Baking powder⁴ | .11 |
| MGP Pregel-40 | 1.11 |
| Artificial flavor⁵ | .22 |
| Guar gum | .09 |
| Sodium Stearoyl Lactylate | .11 |
| Powdered whole eggs | 5.10 |
| Water-1^{st} addition | 15.66 |
| Soybean oil | 12.05 |
| Water-2^{nd} addition | 12.05 |

¹White Plume-Bunge Foods
²Levair-Rhodia Food
³Calumet double acting-Kraft
⁴butter & vanilla 16 to 1-Int. Bakers Services

The foregoing ingredients were mixed according to the following procedure using a twelve speed Sunbeam mixmaster and a large mixing bowl:
1) Blend cake shortening, sucrose, and salt together;
2) Blend all other dry ingredients;
3) Add 1^{st} addition water and oil to blended muffin mix and mix for one minute at first speed;
4) Mix for two minutes at third speed;
5) Add 2^{nd} addition water and mix for one minute at first speed;
6) Scrape bowl and mix for two minutes at first speed
7) Add blueberries, chocolate chips or other desired ingredients of similar nature, and fold into the mixture;
8) Scale for large muffins 122 g +/−2 g.
9) bake @ 375 F for 30-33 min

### EXAMPLE 21

### Low Carbohydrate Muffin Formulation

A muffin formulation was prepared in which 50% of the conventional flour was replaced using a resistant starch, FiberStar™70.

| Ingredients | Total Weight % |
|---|---|
| FiberStar ™ 70 | 9.25 |
| Vital Wheat Gluten | 1.98 |
| Cake flour | 8.81 |
| Bread flour | 2.20 |
| Nonfat Dry Milk | 2.20 |
| Sucrose | 24.24 |
| Salt | .42 |
| Cake shortening¹ | 3.31 |
| Soda | .33 |
| Sodium Aluminum Phosphate² | .33 |
| Baking powder³ | .13 |
| MGP Pregel-40 | 1.10 |
| Whey protein isolate | .22 |
| Potato flour | .22 |
| Artificial flavor⁴ | .22 |
| Guar gum | .09 |
| Sodium Stearoyl Lactylate | .11 |
| Powdered whole eggs | 5.07 |
| Water-1^{st} addition | 15.66 |
| Soybean oil | 12.05 |
| Water-2^{nd} addition | 12.05 |

¹White Plume-Bunge Foods
²Levair-Rhodia Food
³Calumet double acting-Kraft
⁴butter & vanilla 16 to 1-Int. Bakers Services

The foregoing ingredients were mixed according to the following procedure using a twelve speed Sunbeam mixmaster and a large mixing bowl:
1) Blend cake shortening, sucrose, and salt together;
2) Blend all other dry ingredients;
3) Add 1^{st} addition water and oil to blended muffin mix and mix for one minute at first speed;
4) Mix for two minutes at third speed;
5) Add 2^{nd} addition water and mix for one minute at first speed;
6) Scrape bowl and mix for two minutes at first speed
7) Add blueberries, chocolate chips or other desired ingredients of similar nature, and fold into the mixture;
8) Scale for large muffins 122 g +/−2 g.
9) Bake @ 375° F. for 30-33 minutes.

### EXAMPLE 22

### Low Carbohydrate Muffin Formulation

A muffin formulation was prepared in which 75% of the conventional flour was replaced using a resistant starch, FiberStar™ 70.

| Ingredients | Total Weight % |
|---|---|
| FiberStar ™ 70 | 13.65 |
| Vital Wheat Gluten | 3.03 |
| Cake flour | 4.39 |
| Bread flour | 1.10 |
| Nonfat Dry Milk | 2.19 |
| Sucrose | 24.13 |
| Salt | .42 |
| Cake shortening¹ | 3.29 |
| Soda | .33 |
| Sodium Aluminum Phosphate² | .33 |
| Baking powder³ | .13 |
| MGP Pregel-40 | 1.10 |
| Whey protein isolate | .22 |
| Potato flour | .22 |
| Artificial flavor⁴ | .22 |
| Guar gum | .09 |
| Sodium Stearoyl Lactylate | .15 |
| Powdered whole eggs | 5.27 |
| Water-1^{st} addition | 15.66 |
| Soybean oil | 12.05 |
| Water-2^{nd} addition | 12.05 |

¹White Plume-Bunge Foods
²Levair-Rhodia Food
³Calumet double acting-Kraft
⁴butter & vanilla 16 to 1-Int. Bakers Service

The foregoing ingredients were mixed according to the following procedure using a twelve speed Sunbeam mixmaster and a large mixing bowl:
1) Blend cake shortening, sucrose, and salt together;
2) Blend all other dry ingredients;
3) Add 1^{st} addition water and oil to blended muffin mix and mix for one minute at first speed;
4) Mix for two minutes at third speed;
5) Add 2^{nd} addition water and mix for one minute at first speed;
6) Scrape bowl and mix for two minutes at first speed
7) Add blueberries, chocolate chips or other desired ingredients of similar nature, and fold into the mixture;
8) Scale for large muffins 122 g +/−2 g.
9) Bake @ 375° F. for 30-33 minutes.

### EXAMPLE 23

### Low Carbohydrate Brownie Formulation (Prior Art)

A conventional brownie recipe was improved by substituting the conventional flour content with FiberStar™ in an amount ranging from 25% to 75% by weight of the conventional flour, as shown in Examples 20-22. The resultant flour content may be defined as containing amylase resistant starch.

Tables 11A, B and C replicate the food labeling information as might appear on a commercially available package of brownie mix where none of the “All Purpose White Flour” of the prior art has been replaced using FiberStar™ 70.

TABLE 11A
Brownie Ingredients (Prior Art)

| | | | | |
|---|---|---|---|---|
| Total Weight: | 536.16 | g | (18.91 | oz-wt.) |
| Serving Size: | 30.00 | g | (1.06 | oz-wt.) |

| | |
|---|---|
| Serves: | 17.87 |

| Amount for | | | | | | | |
|---|---|---|---|---|---|---|---|
| 17.872 | | | Amount for | | | ESHA | % Total |
| servings | | Food Item | 1 serving | | Cost | Code | Weight |
| 113.5 | g | Butter-Salted LOL | 6.35072 | g | — | 8791 | 21.17% |
| 216.4 | g | Sucrose | 12.1083 | g | — | 25035 | 40.36% |
| 4.33 | g | Pure Vanilla Extract | 0.24228 | g | — | 26087 | 0.81% |
| | | Flavor (Single Fold) VD | | | | | |
| 100 | g | Meas. Raw: Egg-Large- | 5.59534 | g | — | 19510 | 16.60% |
| | | Bld-Each | | | | | |
| 67.5 | g | All Purpose White Flour | 3.77686 | g | — | 38030 | 12.59% |
| | | Enriched-Blchd* | | | | | |
| 43.33 | g | Alkalized Dutch Cocoa | 2.42446 | g | — | 28203 | 8.08% |
| | | Powder-R 10/12 | | | | | |
| 0.975 | g | Clabber Girl Baking | 0.05455 | g | — | 28073 | 0.18% |
| | | Powder HUL | | | | | |
| 1.125 | g | Table Salt | 0.06295 | g | — | 26014 | 0.21% |

*Control amount-no replacement.

TABLE 11B
Brownie Nutrients Per Serving (Prior Art)

| | | | | | |
|---|---|---|---|---|---|
| Calories | 120.77 | | Fat - Total | 5.82 | g |
| Protein | 1.55 | g | Saturated Fat | 3.80 | g |
| Carbohydrates | 16.27 | g | Vitamin A RE | 44.66 | RE |
| Dietary Fiber | 0.81 | g | Vitamin C | 0 | mg |
| % Calories from fat | 42% | | % Calories from carbs | 52% | |

TABLE 11C
Brownie Nutrition (Prior Art)
Nutrition Facts

| Serving Size (30 g) | |
|---|---|
| Servings Per Container | |
| Amount Per Serving | |
| Calories 130 | Calories from Fat 50 |
| | % Daily Value* |
| Total Fat 6 g | 9% |
| Saturated Fat 4 g | 20% |
| Cholesterol 30 mg | 9% |
| Sodium 140 mg | 6% |
| Total Carbohydrates 17 g | 6% |
| Dietary Fiber 3 g | 13% |
| Sugars 10 g | |
| Protein 1 g | |

| | | |
|---|---|---|
| Vitamin A 4% | * | Vitamin C 0% |
| Calcium 2% | * | Iron 2% |

*Percent Daily Values are based on a 2,000 calorie diet. Your daily
values may be higher or lower depending on your calorie needs.

| | | |
|---|---|---|
| Calories: | 2,000 | 2,500 |

| | | | | | |
|---|---|---|---|---|---|
| Total Fat | Less than | 65 | g | 80 | g |
| Saturated Fat | Less than | 20 | g | 25 | g |
| Cholesterol | Less than | 300 | mg | 300 | mg |
| Sodium | Less than | 2,400 | mg | 2,400 | mg |
| Total Carbohydrate | | 300 | g | 375 | g |
| Dietary Fiber | | 25 | g | 30% | |

Calories per gram:
Fat 9 - Carbohydrate 4 - Protein 4

### EXAMPLE 24

### Low Carbohydrate Brownie Formulation

Tables 12A, B and C replicate the food labeling information as might appear on a commercially available package of brownie mix where 25% of the “All Purpose White Flour” of the prior art has been replaced using FiberStar™ 70.

TABLE 12A
Brownie Ingredients

| | | | | |
|---|---|---|---|---|
| Total Weight: | 536.16 | g | (18.91 | oz-wt.) |
| Serving Size: | 30.00 | g | (1.06 | oz-wt.) |

| | |
|---|---|
| Serves: | 17.87 |

| Amount for | | | | | | | |
|---|---|---|---|---|---|---|---|
| 17.872 | | | Amount for | | | ESHA | % Total |
| servings | | Food Item | 1 serving | | Cost | Code | Weight |
| 113.5 | g | Butter-Salted LOL | 6.35072 | g | — | 8791 | 21.17% |
| 216.4 | g | Sucrose | 12.1083 | g | — | 25035 | 40.36% |
| 4.33 | g | Pure Vanilla Extract | 0.24228 | g | — | 26087 | 0.81% |
| | | Flavor (Single Fold) VD | | | | | |
| 100 | g | Meas. Raw: Egg-Large- | 5.59534 | g | — | 19510 | 16.60% |
| | | Bld-Each | | | | | |
| 50.625 | g | All Purpose White Flour | 2.83264 | g | — | 38030 | 9.44% |
| | | Enriched-Blchd* | | | | | |
| 43.33 | g | Alkalized Dutch Cocoa | 2.42446 | g | — | 28203 | 8.08% |
| | | Powder-R 10/12 | | | | | |
| 0.975 | g | Clabber Girl Baking | 0.05455 | g | — | 28073 | 0.18% |
| | | Powder HUL | | | | | |
| 1.125 | g | Table Salt | 0.06295 | g | — | 26014 | 0.21% |
| 14.85 | g | FiberStar ™ 70 | 0.83091 | g | | | 2.77% |
| 2.025 | g | Vital Wheat Gluten | 0.11331 | g | | | 0.38% |

*25% of this ingredient was replaced with FiberStar ™ 70.

TABLE 12B
Brownie Nutrients Per Serving

| | | | | | |
|---|---|---|---|---|---|
| Calories | 120.77 | | Fat - Total | 5.82 | g |
| Protein | 1.55 | g | Saturated Fat | 3.80 | g |
| Carbohydrates | 16.30 | g | Vitamin A RE | 44.68 | RE |
| Dietary Fiber | 1.36 | g | Vitamin C | 0 | mg |
| % Calories from fat | 42% | | % Calories from carbs | 52% | |

TABLE 12B
Brownie Nutrition
Nutrition Facts

| Serving Size (30 g) | |
|---|---|
| Servings Per Container | |
| Amount Per Serving | |
| Calories 120 | Calories from Fat 50 |
| | % Daily Value* |
| Total Fat 6 g | 9% |
| Saturated Fat 4 g | 19% |
| Cholesterol 35 mg | 12% |
| Sodium 75 mg | 3% |
| Total Carbohydrates 16 g | 5% |
| Dietary Fiber 1 g | 5% |
| Sugars 12 g | |
| Protein 2 g | |

| | | |
|---|---|---|
| Vitamin A 4% | * | Vitamin C 0% |
| Calcium 0% | * | Iron 2% |

*Percent Daily Values are based on a 2,000 calorie diet. Your daily
values may be higher or lower depending on your calorie needs.

| | | |
|---|---|---|
| Calories: | 2,000 | 2,500 |

| | | | | | |
|---|---|---|---|---|---|
| Total Fat | Less than | 65 | g | 80 | g |
| Saturated Fat | Less than | 20 | g | 25 | g |
| Cholesterol | Less than | 300 | mg | 300 | mg |
| Sodium | Less than | 2,400 | mg | 2,400 | mg |
| Total Carbohydrate | | 300 | g | 375 | g |
| Dietary Fiber | | 25 | g | 30% | |
| Calories per gram: | | | | | |

Fat 9 - Carbohydrate 4 - Protein 4

### EXAMPLE 25

### Low Carbohydrate Brownie Formulation

Tables 13A, B and C replicate the food labeling information as might appear on a commercially available package of brownie mix where 50% of the “All Purpose White Flour” of the prior art has been replaced using FiberStar™ 70.

TABLE 13A
Brownie Ingredients

| | | | | |
|---|---|---|---|---|
| Total Weight: | 536.16 | g | (18.91 | oz-wt.) |
| Serving Size: | 30.00 | g | (1.06 | oz-wt.) |

| | |
|---|---|
| Serves: | 17.87 |

| Amount for | | | | | | | |
|---|---|---|---|---|---|---|---|
| 17.872 | | | Amount for | | | ESHA | % Total |
| servings | | Food Item | 1 serving | | Cost | Code | Weight |
| 113.5 | g | Butter-Salted LOL | 6.35072 | g | — | 8791 | 21.17% |
| 216.4 | g | Sucrose | 12.1083 | g | — | 25035 | 40.36% |
| 4.33 | g | Pure Vanilla Extract | 0.24228 | g | — | 26087 | 0.81% |
| | | Flavor (Single Fold) VD | | | | | |
| 100 | g | Meas. Raw: Egg-Large- | 5.59534 | g | — | 19510 | 16.60% |
| | | Bld-Each | | | | | |
| 33.75 | g | All Purpose White Flour | 1.88843 | g | — | 38030 | 6.29% |
| | | Enriched-Blchd* | | | | | |
| 43.33 | g | Alkalized Dutch Cocoa | 2.42446 | g | — | 28203 | 8.08% |
| | | Powder-R 10/12 | | | | | |
| 0.975 | g | Clabber Girl Baking | 0.05455 | g | — | 28073 | 0.18% |
| | | Powder HUL | | | | | |
| 1.125 | g | Table Salt | 0.06295 | g | — | 26014 | 0.21% |
| 29.7 | g | FiberStar ™ 70 | 1.66182 | g | | | 5.54% |
| 4.05 | g | Vital Wheat Gluten | 0.22661 | g | | | 0.76% |

*50% of this ingredient was replaced with FiberStar ™ 70.

TABLE 13B
Brownie Nutrition Per Serving

| | | | | | |
|---|---|---|---|---|---|
| Calories | 120.65 | | Fat - Total | 5.82 | g |
| Protein | 1.55 | g | Saturated Fat | 3.80 | g |
| Carbohydrates | 16.34 | g | Vitamin A RE | 44.70 | RE |
| Dietary Fiber | 1.92 | g | Vitamin C | 0 | mg |
| % Calories from fat | 42% | | % Calories from carbs | 53% | |

TABLE 13C
Brownie Nutrition
Nutrition Facts

| Serving Size (30 g) | |
|---|---|
| Servings Per Container | |
| Amount Per Serving | |
| Calories 120 | Calories from Fat 50 |
| | % Daily Value* |
| Total Fat 6 g | 9% |
| Saturated Fat 4 g | 19% |
| Cholesterol 35 mg | 12% |
| Sodium 75 mg | 3% |
| Total Carbohydrates 16 g | 5% |
| Dietary Fiber 2 g | 8% |
| Sugars 12 g | |
| Protein 2 g | |

| | | |
|---|---|---|
| Vitamin A 4% | * | Vitamin C 0% |
| Calcium 0% | * | Iron 0% |

*Percent Daily Values are based on a 2,000 calorie diet. Your daily
values may be higher or lower depending on your calorie needs.

| | | |
|---|---|---|
| Calories: | 2,000 | 2,500 |

| | | | | | |
|---|---|---|---|---|---|
| Total Fat | Less than | 65 | g | 80 | g |
| Saturated Fat | Less than | 20 | g | 25 | g |
| Cholesterol | Less than | 300 | mg | 300 | mg |
| Sodium | Less than | 2,400 | mg | 2,400 | mg |
| Total Carbohydrate | | 300 | g | 375 | g |
| Dietary Fiber | | 25 | g | 30% | |
| Calories per gram: | | | | | |

Fat 9 - Carbohydrate 4 - Protein 4

### EXAMPLE 26

### Low Carbohydrate Brownie Formulation

Tables 14A, B and C replicate the food labeling information as might appear on a commercially available package of brownie mix where 75% of the “All Purpose White Flour” of the prior art has been replaced using FiberStar™70.

TABLE 14A
Brownie Ingredients

| | | | | |
|---|---|---|---|---|
| Total Weight: | 536.16 | g | (18.91 | oz-wt.) |
| Serving Size: | 30.00 | g | (1.06 | oz-wt.) |

| | |
|---|---|
| Serves: | 17.87 |

| Amount for | | | | | | | |
|---|---|---|---|---|---|---|---|
| 17.872 | | | Amount for | | | ESHA | % Total |
| servings | | Food Item | 1 serving | | Cost | Code | Weight |
| 113.5 | g | Butter-Salted LOL | 6.35072 | g | — | 8791 | 21.17% |
| 216.4 | g | Sucrose | 12.1083 | g | — | 25035 | 40.36% |
| 4.33 | g | Pure Vanilla Extract | 0.24228 | g | — | 26087 | 0.81% |
| | | Flavor (Single Fold) VD | | | | | |
| 100 | g | Meas. Raw: Egg-Large- | 5.59534 | g | — | 19510 | 16.60% |
| | | Bld-Each | | | | | |
| 16.875 | g | All Purpose White Flour | 0.94421 | g | — | 38030 | 3.15% |
| | | Enriched-Blchd* | | | | | |
| 43.33 | g | Alkalized Dutch Cocoa | 2.42446 | g | — | 28203 | 8.08% |
| | | Powder-R 10/12 | | | | | |
| 0.975 | g | Clabber Girl Baking | 0.05455 | g | — | 28073 | 0.18% |
| | | Powder HUL | | | | | |
| 1.125 | g | Table Salt | 0.06295 | g | — | 26014 | 0.21% |
| 44.55 | g | FiberStar ™ 70 | 2.49273 | g | | | 8.31% |
| 6.075 | g | Vital Wheat Gluten | 0.33992 | g | | | 1.13% |

*75% of this ingredient was replaced with FiberStar ™ 70.

TABLE 14B
Brownie Nutrition Per Serving

| | | | | | |
|---|---|---|---|---|---|
| Calories | 120.59 | | Fat - Total | 5.81 | g |
| Protein | 1.55 | g | Saturated Fat | 3.79 | g |
| Carbohydrates | 16.37 | g | Vitamin A RE | 44.72 | RE |
| Dietary Fiber | 2.48 | g | Vitamin C | 0 | mg |
| % Calories from fat | 42% | | % Calories from carbs | 53% | |

TABLE 14C
Brownie Nutrition
Nutrition Facts

| Serving Size (30 g) | |
|---|---|
| Servings Per Container | |
| Amount Per Serving | |
| Calories 120 | Calories from Fat 50 |
| | % Daily Value* |
| Total Fat 6 g | 9% |
| Saturated Fat 4 g | 19% |
| Cholesterol 35 mg | 12% |
| Sodium 75 mg | 3% |
| Total Carbohydrates 16 g | 5% |
| Dietary Fiber 2 g | 10% |
| Sugars 12 g | |
| Protein 2 g | |

| | | |
|---|---|---|
| Vitamin A 4% | * | Vitamin C 0% |
| Calcium 2% | * | Iron 2% |

*Percent Daily Values are based on a 2,000 calorie diet. Your daily
values may be higher or lower depending on your calorie needs.

| | | |
|---|---|---|
| Calories: | 2,000 | 2,500 |

| | | | | | |
|---|---|---|---|---|---|
| Total Fat | Less than | 65 | g | 80 | g |
| Saturated Fat | Less than | 20 | g | 25 | g |
| Cholesterol | Less than | 300 | mg | 300 | mg |
| Sodium | Less than | 2,400 | mg | 2,400 | mg |
| Total Carbohydrate | | 300 | g | 375 | g |
| Dietary Fiber | | 25 | g | 30% | |
| Calories per gram: | | | | | |

Fat 9 - Carbohydrate 4 - Protein 4

### EXAMPLE 27

### High-Protein, Low-Carbohydrate Bread

| Ingredients | Baker's Percent |
|---|---|
| Vital Wheat Gluten | 111.1 |
| Bread Flour | 100.0 |
| Wheat Protein Isolate¹ | 27.8 |
| Hydrolyzed Wheat Protein² | 16.7 |
| Yeast | 11.1 |
| Whey Protein | 16.7 |
| Flavor (Butter, Masking) | 2.2 |
| Salt | 5.0 |
| Sucralose (Artificial Sweetener) | 0.1 |
| Water | 264.0 |

¹Arise ™ 5000 available from MGP Ingredients.
²HWG ™ 2009 available from MGP Ingredients.

### EXAMPLE 28

### High-Protein, Low-Carbohydrate Bread

| Ingredients | Baker's Percent |
|---|---|
| Vital Wheat Gluten | 111.1 |
| Bread Flour | 100.0 |
| Wheat Protein Isolate¹ | 44.5 |
| Yeast | 11.1 |
| Whey Protein | 16.7 |
| Flavor (Butter, Masking) | 2.2 |
| Salt | 5.0 |
| Sucralose (Artificial Sweetener) | 0.1 |
| Water | 264.0 |

¹Arise ™ 5000 available from MGP Ingredients.

### EXAMPLE 29

### High-Protein, Low-Carbohydrate Bread

| Ingredients | Baker's Percent |
|---|---|
| Vital Wheat Gluten | 111.1 |
| Bread Flour | 100.0 |
| Wheat Protein Isolate¹ | 44.5 |
| Yeast | 11.1 |
| Whey Protein | 16.7 |
| Flavor (Butter, Masking) | 2.2 |
| Salt | 5.0 |
| Sucralose (Artificial Sweetener) | 0.1 |
| Fungal Protease | 0.03 |
| Water | 264.0 |

¹Arise ™ 5000 available from MGP Ingredients.

### EXAMPLE 30

### High-Protein, Low-Carbohydrate Bread

| Ingredients | Baker's Percent |
|---|---|
| Vital Wheat Gluten | 111.1 |
| Bread Flour | 100.0 |
| Soy Protein Isolate | 44.5 |
| Yeast | 11.1 |
| Whey Protein | 16.7 |
| Flavor (Butter, Masking) | 2.2 |
| Salt | 5.0 |
| Sucralose (Artificial Sweetener) | 0.1 |
| Fungal Protease | 0.03 |
| Water | 264.0 |

### EXAMPLE 31

### High-Protein, Low-Carbohydrate Bread

| Ingredients | Baker's Percent |
|---|---|
| Vital Wheat Gluten | 111.1 |
| Bread Flour | 100.0 |
| Wheat Protein Concentrate¹ | 44.5 |
| Yeast | 10.0 |
| Whey Protein | 16.7 |
| Flavor (Butter, Masking) | 1.1 |
| Salt | 5.0 |
| Sucralose (Artificial Sweetener) | 0.1 |
| Water | 264.0 |

¹FP 500 available from MGP Ingredients.

### EXAMPLE 32

### High-Protein, Low-Carbohydrate Bread

| Ingredients | Baker's Percent |
|---|---|
| Vital Wheat Gluten | 111.1 |
| Bread Flour | 100.0 |
| Wheat Protein Concentrate¹ | 44.5 |
| Yeast | 10.0 |
| Whey Protein | 16.7 |
| Flavor putter, Masking) | 1.1 |
| Salt | 5.0 |
| Sucralose (Artificial Sweetener) | 0.1 |
| Devitalized Wheat Gluten² | 20.8 |
| Water | 285.0 |

¹FP 500 available from MGP Ingredients.
²Wheatex ™ 16 available from MGP Ingredients.

### EXAMPLE 33

### High-Protein, Low-Carbohydrate Whole Wheat Bread

| Ingredients | Baker's Percent |
|---|---|
| Whole Wheat Flour | 100.0 |
| Vital Wheat Gluten | 62.5 |
| Wheat Protein Isolate¹ | 50.0 |
| Compressed Yeast | 8.8 |
| Shortening | 8.8 |
| Salt | 2.5 |
| Sucralose (Artificial Sweetener) | 0.1 |
| Water | 190.0 |

¹Arise ™ 6000 available from MGP Ingredients.

### EXAMPLE 34

### High-Protein, Low-Carbohydrate Whole Wheat Bread

| Ingredients | Baker's Percent |
|---|---|
| Whole White Wheat Flour | 100.0 |
| Vital Wheat Gluten | 62.5 |
| Wheat Protein Isolate¹ | 50.0 |
| Cornmessed Yeast | 8.8 |
| Shortening | 8.8 |
| Salt | 2.5 |
| Sucralose (Artificial Sweetener) | 0.1 |
| Water | 190.0 |

¹Arise ™ 6000 available from MGP Ingredients.

### EXAMPLE 35

### High-Protein, Low-Carbohydrate White Pan Bread

| Ingredients | Baker's Percent |
|---|---|
| Whole White Wheat Flour | 100.0 |
| Vital Wheat Gluten | 62.5 |
| Wheat Protein Isolate¹ | 50.0 |
| Compressed Yeast | 8.8 |
| Shortening | 8.8 |
| Salt | 2.5 |
| Sucralose (Artificial Sweetener) | 0.1 |
| Water | 170.0 |

¹Arise ™ 6000 available from MGP Ingredients

### EXAMPLE 36

### High-Protein, Low-Carbohydrate White Pan Bread

| Ingredients | Baker's Percent |
|---|---|
| Bread Flour | 100.0 |
| Vital Wheat Gluten | 62.5 |
| Wheat Protein Isolate¹ | 50.0 |
| Resistant Starch² | 12.5 |
| Compressed Yeast | 8.8 |
| Shortening | 8.8 |
| Salt | 2.5 |
| Sucralose (Artificial Sweetener) | 0.1 |
| Water | 170.0 |

¹Arise ™ 6000 available from MGP Ingredients.
²FiberStar ™ 70 available from MGP Ingredients.

### EXAMPLE 37

### High-Protein, Low-Carbohydrate White Pan Bread

| Ingredients | Baker's Percent |
|---|---|
| Bread Flour | 100.0 |
| Vital Wheat Gluten | 62.5 |
| Wheat Protein Isolate¹ | 50.0 |
| Resistant Starch² | 12.5 |
| Devitalized Wheat Gluten³ | 5.0 |
| Compressed Yeast | 8.8 |
| Shortening | 8.8 |
| Salt | 2.5 |
| Sucralose (Artificial Sweetener) | 0.1 |
| Water | 170.0 |

¹Arise ™ 6000 available from MGP Ingredients.
²FiberStar ™ 70 available from MGP Ingredients.
³Wheatex ™ 16 available from MGP Ingredients.

### EXAMPLE 38

### High-Protein, Low-Carbohydrate Whole Wheat Bread

| Ingredients | Baker's Percent |
|---|---|
| Whole Wheat Flour | 100.0 |
| Vital Wheat Gluten | 25.7 |
| Wheat Protein Isolate¹ | 50.0 |
| Hydrolized Wheat Protein² | 17.1 |
| Resistant Starch³ | 21.4 |
| Compressed Yeast | 9.3 |
| Salt | 2.9 |
| Water | 107 |
| Vegetable Oil | 10.7 |
| Sucralose (Artificial Sweetener) | 0.03 |
| Calcium Propionate | 0.65 |
| Diacetyl Tartaric Acid Esters of | 0.60 |
| Mono- and Diglycerides | |
| Sodium Stearoyl Lactylate | 0.60 |
| Azodicarbonamide | 0.006 |
| Ascorbic Acid | 0.02 |
| Natural Butter Flavor | 0.36 |

¹Arise ™ 6000 available from MGP Ingredients.
²HWG ™ 2009 available from MGP Ingredients.
³FiberStar ™ 70 available from MGP Ingredients.

In this Example, all dry ingredients were blended together until completely uniform. Liquid ingredients were added next and mixed for 1 minute on low and 5.5 minutes on high speed using Hobart mixer (Hobart Corp.) equipped with a spiral dough hook. Dough scaling weight followed a pan factor of 2.05. The dough weight was determined by dividing the area (in square inches) of the top of the bread pan by 2.05. The dough was proofed at 110° F. and 85% relative humidity, and then baked at 400° F. for 25 minutes.

### EXAMPLE 39

### High-Protein, Low-Carbohydrate Bagel

| Ingredients | Baker's Percent |
|---|---|
| Vital Wheat Gluten | 111.1 |
| (Bread Flour | 100.0 |
| Wheat Protein Concentrate¹ | 50.0 |
| Yeast | 10.0 |
| Whey Protein | 16.7 |
| Flavor (Butter, Masking) | 1.10 |
| Salt | 6.0 |
| Sucralose (Artificial Sweetener) | 0.1 |
| L-Cysteine | 0.005 |
| Water | 267.0 |

¹FP 500 available from MGP Ingredients.

In this Example, all dry ingredients were blended together until completely homogeneous. Water was added to blended ingredients and mixed to optimum development using a Hobart mixer (Hobart Corp.). About 4.3 ounces of bagel dough was weighed, proofed briefly, and baked in an oven (with steam) at 390° F. for 17-22 minutes.

### EXAMPLE 40

### Low Carbohydrate French Cruller Doughnut

| Ingredient | Baker's Percent |
|---|---|
| Vital Wheat Gluten | 1.13 |
| Deamidated Wheat Gluten¹ | 1.00 |
| Resistant Starch² | 7.00 |
| Water | 43.00 |
| Whole eggs | 25.40 |
| Pregel 10FC | 14.60 |
| Carboxymethyl cellulose | 0.08 |
| Sodium caseinate | 0.62 |
| All purpose shortening | 5.80 |
| 65 A type emulsifier | 0.85 |
| Baking soda | 0.06 |
| Sodium acid pyrophosphate 40 | 0.02 |
| Monocalcium phosphate | 0.08 |
| (particle size 12 XX) | |
| Flavor | 0.03 |
| Color (beta-carotene) | 0.03 |
| Salt | 0.30 |

¹WPI 2100 available from MGP Ingredients.
²FiberStar ™ 70 available from MGP Ingredients.

This French Cruller doughnut is an example of a chemically leavened, fried product. All ingredients (except the water and eggs) were mixed until uniform. Hot water (125-130° F.) was added and the batter mixed on low speed for 30 seconds. The mixer speed was increased to medium and the batter mixed an additional two minutes, at which time the eggs were added and the batter mixed on low speed for one minute. The batter was mixed an additional three minutes on medium speed. The temperature of the batter was between 85-90° F. The doughnuts were fried for 2¾minutes on the first side, then turned and fried for three minutes on the second side, and finally turned again and fried for 15 seconds.

### EXAMPLE 41

### Low Carbohydrate Chocolate Cake Doughnut

| Ingredient | Baker's Percent |
|---|---|
| Flour | 100.0 |
| Sugar (ultrafine pure cane) | 99.3 |
| Crystalline fructose | 17.1 |
| Dextrose 333 | 1.3 |
| Defatted soy flour | 8.6 |
| Corn flour | 6.4 |
| Wheat Protein Isolate¹ | 11.8 |
| Vital Wheat Gluten | 10.0 |
| Resistant Starch² | 90.0 |
| Dried egg yolk | 8.6 |
| Salt | 3.9 |
| Pregel 46 | 2.1 |
| Pregel 10 | 2.1 |
| Powdered lecithin | 1.1 |
| Sodium bicarbonate | 3.2 |
| Sodium acid pyrophosphate #28 | 1.7 |
| Sodium acid pyrophosphate #37 | 3.9 |
| Carboxymethyl cellulose | 0.2 |
| Sodium propionate | 2.1 |
| Dutched cocoa | 33.6 |
| Vegetable oil | 18.8 |
| Emulsifier | 1.2 |
| Pure vanilla extract | 1.5 |

¹Arise ™ 5000 available from MGP Ingredients.
²FiberStar ™ 70 available from MGP Ingredients.

In the chocolate cake donut formula (a chemically-leavened, fried product), the emulsifier and sugar were creamed together. All dry ingredients were then incorporated to the creamed sugar mixture for 10 minutes at speed 2 in a Kitchen Aid mixer (Hobart Corp.) equipped with a paddle. Water at 81° F. was added and mixed for one minute at speed 1 and at speed 2 for one minute and 35 seconds. The quantity of water ranged from 46-48% of the dry mix weight. The batter temperature was between 76-78° F. The batter was rested for 6 minutes at room temperature, and then fried for one minute on each side.

### EXAMPLE 42

### Blueberry Muffin Mix

| Ingredient | Baker's Percent |
|---|---|
| Flour | 100.0 |
| Vital Wheat Gluten | 5.0 |
| Fractionated Wheat Protein¹ | 5.0 |
| Resistant Starch² | 90.0 |
| Sucrose | 160.0 |
| Nonfat dry milk | 20.0 |
| All purpose shortening | 57.4 |
| Emulsified shortening | 17.0 |
| Salt | 3.8 |
| Baking powder | 10.0 |
| Pregel 40 | 8.0 |
| Flavor | 2.0 |
| Xantham gum | 0.4 |
| Guar gum | 0.4 |
| Sodium stearoyl lactylate | 0.5 |
| Blueberries | 60.0 |
| Whole eggs | 40.0 |
| Water | 50.0 |

¹Gliadin available from MGP Ingredients
²FiberStar ™ 70 available from MGP Ingredients.

This blueberry muffin mix is an example of a chemically-leavened, baked product. The sugar, salt, and shortening were blended together until uniform. The remaining ingredients (except for the eggs and water) were added and mixed until uniform. The eggs were added along with half of the water and the batter was mixed in a mixer on medium speed for 2 minutes. Then, the remaining water was added and the batter mixed on low speed for an additional 2 minutes. The blueberries were gently folded into the batter which was then poured into muffin cups. Baking time and temperature will largely depend upon muffin size, however, generally, a 75 gram muffin will be baked at 400° F. for 20 minutes.

### EXAMPLE 43

### Low Carbohydrate Pound Cake

| Ingredients | Baker's Percent |
|---|---|
| Granulated sugar | 201.0 |
| Salt | 4.2 |
| Nonfat dry milk | 10.6 |
| Cake flour | 100.0 |
| Vital Wheat Gluten | 7.4 |
| Devitalized Wheat Gluten¹ | 18.1 |
| Resistant Starch | 74.5 |
| Shortening (Emulsified) | 119.1 |
| Pregel 40 | 7.4 |
| Water | 76.5 |
| Whole eggs | 68.1 |
| Yolks | 51.0 |
| Flavor | 4.2 |
| Baking powder | 2.2 |

¹Wheatex ™ available from MGP Ingredients.
²FiberStar ™ 70 available from MGP Ingredients.

This pound cake is an example of a chemically-leavened, baked product. All ingredients (except for the eggs and water) were blended together until uniform. The water was added and the batter mixed until smooth. The eggs were hen added in three stages and mixed until the batter was uniform and fluffy. The cake was baked at 375° F. for 45-50 minutes.

### EXAMPLE 44

### Low Carbohydrate Chocolate Cake

| Ingredient | Baker's Percent |
|---|---|
| sugar | 229.6 |
| Salt | 4.5 |
| Nonfat dry milk | 26.7 |
| Cocoa (10112 natural) | 40.0 |
| Cake flow | 100.0 |
| Vital Wheat Gluten | 4.8 |
| Wheat Protein Isolate¹ | 9.5 |
| Resistant Starch² | 94.6 |
| Pregel 40 | 4.1 |
| Shortening with emulsifier | 89.1 |
| Baking powder | 9.0 |
| Water | 228.6 |
| Flavor | 4.5 |
| Whole eggs | 107.6 |

¹Arise ™ 3000 available from MGP Ingredients.
²FiberStar ™ 70 available from MGP Ingredients.

This chocolate cake is an example of a chemically-leavened, baked product. All ingredients (except for the water) were blended together until dorm. Next, 60% of the water was added and the batter mixed on medium speed for 3 minutes. The bowl was scraped, the remaining water was added, and the batter mixed on low speed for 2-3 minutes. The batter was poured into pans and baked at 400° F. until the center was done.

A chocolate cake mixture was prepared using different types of retrograde starch to substitute for the conventional flour. Table 15 provides a TDF analysis of the formulations.

TABLE 15
Total Dietary Fiber (TDF) Content of Chocolate Cake
(15% of the Flour Replaced with Resistant Starch)

| Replacement Ingredient | TDF % |
|---|---|
| Control (No replacement-100% | 4.9% |
| of prior art flour) | |
| FiberStar ™ 70 | 9.4% |
| Novelose ™ 260 | 8.7% |
| High-Maize ™ 1043 | 8.5% |
| Novelose ™ 240 | 7.8% |
| CrystaLean ™ | 7.6% |
| Novelose ™ 330 | 7.3% |

### EXAMPLE 45

### Low Carbohydrate Yellow or White Cake

| Ingredient | Baker's Percent |
|---|---|
| sugar | 203.8 |
| Salt | 4.2 |
| Nonfat dry milk | 17.7 |
| Cake flour | 100.0 |
| Vital Wheat Gluten | 11.5 |
| Hydrolyzed Wheat Protein² | 3.8 |
| Resistant Starch³ | 84.6 |
| Pregel 10 | 5.2 |
| Shortening with emulsifier | 85.5 |
| Baking powder | 9.6 |
| Water | 136.7 |
| Flavor | 3.9 |
| Eggs¹ | 102.5 |

¹For yellow cake use % whole eggs and % yolks for egg mixture. For white cake use ½ whole eggs and ½ whites for egg mixture.
²HWG ™ 2009 available from MGP Ingredients.
³FiberStar ™ 70 available from MGP Ingredients.

This yellow or white cake is an example of a chemically-leavened, baked product. All ingredients (except for the water and eggs) were blended together until uniform. Sixty percent of the water was added and the batter mixed for 3 minutes on medium speed. The eggs were added and the batter mixed on medium speed for 3 minutes. The remaining water was added and the batter mixed for an additional 2-3 minutes on low speed. The cake was baked at 350° F. for 20 minutes, or until the center was done.

### EXAMPLE 46

### Low Carbohydrate Chocolate Chip Cookies

| Ingredient | Baker's Percent |
|---|---|
| Pastry flour | 100.0 |
| Vital Wheat Gluten | 6.2 |
| Devitalized Wheat Gluten¹ | 3.1 |
| Resistant Starch² | 90.8 |
| Shortening | 91.9 |
| Butter or margarine | 40.1 |
| Brown sugar | 100.0 |
| Sucrose | 100.0 |
| soda | 3.1 |
| Salt | 5.6 |
| Whole eggs | 66.0 |
| Pregel 10 | 10.0 |

¹Wheatex ™ 16 available from MGP Ingredients.
²FiberStar ™ 70 available from MGP Ingredients.

This chocolate chip cookie is an example of a chemically-leavened, baked product. All ingredients (except for the pastry flour) were blended on low speed for approximately 3 minutes. The pastry flour was added and the dough mixed for an additional minute on low speed. Chocolate chips were then added at a desired amount and the dough mixed until the chips were uniformly distributed The dough was made into balls and baked at 370-380° F. for 10-12 minutes.

### EXAMPLE 47

### Low Carbohydrate Fried Pie Crust

| Ingredients | Baker's Percent |
|---|---|
| Flour, soft | 100.0 |
| Vital Wheat Gluten | 6.3 |
| Fractionated Wheat Protein¹ | 3.6 |
| Resistant Starch² | 90.1 |
| Soy Flour | 6.0 |
| High-heat non fat dry milk | 4.0 |
| Sucrose | 8.0 |
| Dextrose | 4.0 |
| Salt | 5.0 |
| Soda | 0.5 |
| Pregel 10 | 3.0 |
| Shortening | 60.0 |
| Ice water | 70.0 |

¹Glutenin available from MGP Ingredients.
²FiberStar ™ 70 available from MGP Ingredients.

The ingredients for fried pie crust were blended together and mixed until uniform. The dough was then formed, filled and deep fried in 350° F. oil until golden brown (approximately 3-4 minutes).

### EXAMPLE 48

### Low Carbohydrate Pie Dough

| Ingredient | Baker's Percent |
|---|---|
| Pastry flour | 100.0 |
| Vital Wheat Gluten | 7.2 |
| Wheat protein Concentrate¹ | 2.0 |
| Resistant Starch² | 90.8 |
| Pregel 10 | 4.0 |
| Salt | 6.7 |
| Dextrose | 6.0 |
| All purpose shortening | 120.0 |
| Ice water | 58.0 |

¹FP ™ 600 available from MGP Ingredients.
²FiberStar ™ 70 available from MGP Ingredients.

The dry ingredients for pie dough were blended together until uniform. The shortening was blended in on low speed for 1-1.5 minutes. Then, the cold water was added and the dough mixed for an additional 30 seconds on low speed. Finally, the dough was formed into pie crust.

### EXAMPLE 49

### Low Fat Crunchy Bar

| Ingredient | Baker's Percent |
|---|---|
| Corn Syrup | 18.5 |
| Vital Wheat Gluten | 1.0 |
| Devitalized Wheat Gluten¹ | 15.0 |
| Wheat Protein Isolates² | 4.0 |
| Chocolate coating | 15.0 |
| Date paste | 10.0 |
| Granola | 8.7 |
| Crisp rice | 7.0 |
| Honey | 10.0 |
| Chocolate chips | 3.0 |
| Coconut | 1.5 |
| Almonds | 1.5 |
| Brown sugar | 4.7 |
| Nutmeg | 0.1 |

¹Arise ™ 6000 available from MGP Ingredients.
²Wheatex ™ 120 available from MGP Ingredients.

All ingredients for the low fat crunch bar (except for the chocolate coating) were mixed together until uniform. The mixture was formed into bars, coated with chocolate and packaged.

### EXAMPLE 50

### Low Carbohydrate Pretzel Dough

| Ingredient | Baker's Percent |
|---|---|
| All purpose flour | 100.0 |
| Wheat Protein Isolate¹ | 5.5 |
| Vital wheat gluten | 11.0 |
| Resistant starch² | 5.5 |
| Shortening | 2.5 |
| Instant yeast | 0.22 |
| Salt | 0.9 |
| Malt | 0.5 |
| Water | 60.0 |

¹Arise ™ 6000 available from MGP Ingredients.
²FiberStar ™ 70 available from MGP Ingredients.

All dry ingredients were mixed together. the water was added and the dough mixed for one minute in a Hobart mixer (Hobart Corp.) at low speed and 8-10 minutes at medium speed. The dough was proofed for 30 minutes (110° F. and 85% relative humidity) and then the dough formed into the desired shape. The dough was allowed to rest for 5 minutes and was then immersed in 0.25% sodium hydroxide solution at 185-190° F. for 25 seconds. The dough was baked at 475-500° F. for 3 minutes and then at 400-425° F. for 3.5 minutes. The pretzels were placed in a drying oven for 30 minutes at 220-300° F.

### EXAMPLE 51

### Low Carbohydrate Extruded Breakfast Cereal

| Ingredient | Baker's Percent |
|---|---|
| Corn flour | 42.0 |
| Wheat flour | 15.0 |
| Vital Wheat Gluten | 1.5 |
| Hydrolyzed Wheat Protein¹ | 0.5 |
| Resistant Starch² | 13.0 |
| Oat flour | 20 |
| sugar | 6 |
| Salt | 2 |

¹HWG ™ 2009 available from MGP Ingredients.
²FiberStar ™ 70 available from MGP Ingredients.

All dry ingredients were blended together until uniform and processed conventionally in a single- or twin-screw extruder to make a fruit loop-type product. Moisture was added in the conditioner as well as from the steam injected into the barrel.

### EXAMPLE 52

### High Protein Whole Wheat Bread (Sponge and Dough)

This example describes preparation of a sponge and dough bread. The respective formulations are as follows:

| Ingredient | Baker's Percent |
|---|---|
| SPONGE | |
| Whole wheat flour | 70.0 |
| Vital wheat gluten | 15.0 |
| Compressed yeast | 4.0 |
| DOUGH | |
| Whole wheat flour | 30.0 |
| Vital wheat gluten | 50.0 |
| Wheat Protein Isolates¹ | 49.0 |
| Hydrolyzed Wheat Protein² | 1.o |
| Compressed yeast | 5.1 |
| Salt | 3.0 |
| Water | 190.2 |
| Shortening | 9.0 |
| Sucralose | 0.04 |
| Calcium propionate | 0.25 |
| Diacetyl tartaric acid esters of | 0.50 |
| mono- and Diglycerides | |

¹Arise ™ 6000 available from MGP Ingredients.
²HWG ™ 2009 available from MGP Ingredients.

The sponge ingredients were first mixed for one minute on low speed, and then mixed for an additional minute on high speed. The sponge was then allowed 3 hours of fermentation time. In preparation of the dough, all of the dough ingredients were added to the sponge and mixed for one minute at low speed followed by one minute of mixing at high speed. The dough was allowed 5 minutes of floor time, and then the dough was scaled to the desired weight. The dough was proofed for 45 minutes at a temperature between 106°-110° F. The dough was baked at 390° F., with steam, for 36 minutes.

### EXAMPLE 53

### Low Carbohydrate Yeast-Raised Donuts

| Ingredients | Baker's Percent |
|---|---|
| Flour | 100.0 |
| Vital Wheat Gluten | 7.5 |
| Wheat Protein Isolate¹ | 5.0 |
| Resistant Starch² | 87.5 |
| sugar | 18.8 |
| Shortening | 25.0 |
| Nonfat dry milk | 6.2 |
| Soy flour | 2.5 |
| Salt | 3.8 |
| Eggs | 2.5 |
| Baking powder | 2.5 |
| Yeast | 10.0 |
| Water | 112.5 |

¹Arise ™ available from MGP Ingredients.
²FiberStar ™ 70 available from MGP Ingredients.

All dry ingredients were mixed together and the water was added. The dough was mixed for one minute at low speed and 9% minutes at medium speed in a Hobart mixer (Hobart Corp.) equipped with a dough hook. The dough was allowed to rest for one hour at room temperature. The dough was divided into pieces and allowed to rest for 15-20 minutes at room temperature. Dough pieces were rolled out and cut to desired weight with a donut cutter. The dough was proofed at 95-115.F for 25-35 minutes. The donuts were fried at 375° F. for 45-60 seconds each side.

### EXAMPLE 54

### Pasta Dietary Fiber

Various pasta formulations were prepared as a mixture of pasta powder and FiberStar™ 70, which was used to replace the pasta powder in various percentages. Table 16 provides the results of dietary fiber analysis.

TABLE 16
Total Dietary Fiber (TDF) Content of Pasta Containing
FiberStar ™ 70 and Pasta Power

| Replacement Ingredient | TDF % |
|---|---|
| Semolina (Control: Pure pasta powder) | 4.9% |
| Semolina, 2% Pasta Power, | 11.6% |
| 10% FiberStar ™ 70 | |
| Semolina, 5.5% Spinach Powder | 6.6% |
| Semolina, 5.% Spinach Powder, | 11.8% |
| 2% Pasta Power, 10% FiberStar ™ 70 | |

The foregoing examples demonstrate the concept of substituting conventional flour with retrograde starch products to provide low carbohydrate and/or high protein food products. This substitution generally results in the production of foods that have acceptable organoleptic qualities that are much the same, if not identical, to the food products of the prior art.

Those skilled in the art will appreciate that the foregoing embodiments teach by way of example by way of nonlimiting illustration to illustrate preferred practices of the instrumentalities described herein. The various embodiments may be subjected to insubstantial changes without departing from the scope and spirit of the invention. Accordingly, the inventors hereby state their intention to rely upon the Doctrine of Equivalents in protecting their full rights in the invention.

1. A food composition for making high-protein, low-carbohydrate food products, with said composition comprising:
a) a quantity of flour mixture including an amount of chemically modified starches which have a high degree of resistance to α-amylase digestion, and
b) from about 1-150 baker's percent of a first proteinaceous ingredient comprising at least about 70% by weight protein, and a second proteinaceous ingredient selected from the group consisting of (i) between about 0.5-100 baker's percent of a wheat protein isolate product; (ii), between about 0.5-100 baker's percent of a wheat protein concentrate product; (iii) between about 0.5-100 baker's percent of a devitalized wheat gluten product; (iv) between about 0.5-20 baker's percent of a fractionated wheat protein product; (v) between about 0.5-20 baker's percent of a deamidated wheat gluten product; (vi) between about 0.5-30 baker's percent of a hydrolyzed wheat protein product; and (vii) any combination of ingredients (i) to (vi).

2. A dough comprising:
a) a quantity of flour mixture including an amount of chemically modified starches which have a high degree of resistance to α-amylase digestion, and
b) from about 1-10 baker's percent of a first proteinaceous ingredient comprising at least about 70% by weight protein, and a second proteinaceous ingredient selected from the group consisting of (i) between about 0.5-100 baker's percent of a wheat protein isolate product; (ii), between about 0.5-100 baker's percent of a wheat protein concentrate product; (iii) between about 0.5-100 baker's percent of a devitalized wheat gluten product; (iv) between about 0.5-20 baker's percent of a fractionated wheat protein product; (v) between about 0.5-20 baker's percent of a deamidated wheat gluten product; (vi) between about 0.5-30 baker's percent of a hydrolyzed wheat protein product; and (vii) any combination of ingredients (i) to (vi).

3. A wheat-containing bakery product comprising:
from about 1-150 baker's percent of a first proteinaceous ingredient comprising at least about 70% by weight protein; and
a second proteinaceous ingredient selected from the group consisting of—
(a) between about 0.5-100 baker's percent of a wheat protein isolate product;
(b) between about 0.5-100 baker's percent of a wheat protein concentrate product;
(c) between about 0.5-100 baker's percent of a devitalized wheat gluten product;
(d) between about 0.5-20 baker's percent of a fractionated wheat protein product;
(e) between about 0.5-20 baker's percent of a deamidated wheat gluten product;
(f) between about 0.5-30 baker's percent of a hydrolyzed wheat protein product; and
(g) any combination of ingredients (a)-(f).

4. A wheat-containing bakery product comprising:
from about 1-150 baker's percent of a first proteinaceous ingredient;
a second proteinaceous ingredient selected from the group consisting of—
(a) between about 0.5-100 baker's percent of a wheat protein isolate product;
(b) between about 0.5-100 baker's percent of a wheat protein concentrate product;
(c) between about 0.5-100 baker's percent of a devitalized wheat gluten product;
(d) between about 0.5-20 baker's percent of a fractionated wheat protein product;
(e) between about 0.5-20 baker's percent of a deamidated wheat gluten product;
(f) between about 0.5-30 baker's percent of a hydrolyzed wheat protein product; and
(g) any combination of ingredients (a)-(f); and
from about 5-120 baker's percent of a resistant starch.

5. A dough comprising:
a quantity of flour;
from about 1-150 baker's percent of a first proteinaceous ingredient comprising at least about 70% by weight protein; and
a second proteinaceous ingredient selected from the group consisting of—
(a) between about 0.5-100 baker's percent of a wheat protein isolate product;
(b) between about 0.5-100 baker's percent of a wheat protein concentrate product;
(c) between about 0.5-100 baker's percent of a devitalized wheat gluten product;
(d) between about 0.5-20 baker's percent of a fractionated wheat protein product;
(e) between about 0.5-20 baker's percent of a deamidated wheat gluten product;
(f) between about 0.5-30 baker's percent of a hydrolyzed wheat protein product; and
(g) any combination of ingredients (a)-(f).

6. A dough comprising:
a quantity of flour:
from about 1-150 baker's percent of a first proteinaceous ingredient;
a second proteinaceous ingredient selected from the group consisting of—
(a) between about 0.5-100 baker's percent of a wheat protein isolate product;
(b) between about 0.5-100 baker's percent of a wheat protein concentrate product;
(c) between about 0.5-100 baker's percent of a devitalized wheat gluten product;
(d) between about 0.5-20 baker's percent of a fractionated wheat protein product;
(e) between about 0.5-20 baker's percent of a deamidated wheat gluten product;
(f) between about 0.5-30 baker's percent of a hydrolyzed wheat protein product;
(g) any combination of ingredients (a)-(f); and
from about 5-120 baker's percent of a resistant starch.

7. In a bread composition having conventional wheat flour, the improvement comprising:
substituting a portion of the conventional wheat flour with an amylase resistant starch in combination with a material selected from the group consisting of a wheat protein isolate a wheat protein concentrate, a devitalized wheat gluten product; a fractionated wheat protein; a deamidated wheat gluten, a hydrolyzed wheat protein product, and combinations thereof, in effective amounts to reduce the available carbohydrate content and increase the dietary fiber content of the bread product without deleteriously affecting the organoleptic qualities of the bread composition.

8. The bread composition of claim 7, including:
a resultant flour content defined as including about 33% by weight white bread flour, 20% vital wheat gluten, 23% amylase resistant starch, 12% wheat protein isolate, and 13% soy fiber.

9. In a bagel composition having conventional wheat flour, the improvement comprising:
substituting a portion of the conventional wheat flour with an amylase resistant starch in combination with a material selected from the group consisting of a wheat protein isolate a wheat protein concentrate, a devitalized wheat gluten product; a fractionated wheat protein; a deamidated wheat gluten, a hydrolyzed wheat protein product, and combinations thereof, in effective amounts to reduce the available carbohydrate content and increase the dietary fiber content of the bread product without deleteriously affecting the organoleptic qualities of the bagel composition.

10. The bagel composition of claim 9, including:
a resultant flour content defined as including about 20% by weight white bread flour, 30% vital wheat gluten, 20% amylase resistant starch, 10% wheat protein isolate, and 10% soy fiber.

11. In a flour tortilla composition having conventional wheat flour, the improvement comprising:
substituting a portion of the conventional wheat flour with an amylase resistant starch in combination with a material selected from the group consisting of a wheat protein isolate a wheat protein concentrate, a devitalized wheat gluten product; a fractionated wheat protein; a deamidated wheat gluten, a hydrolyzed wheat protein product, and combinations thereof, in effective amounts to reduce the available carbohydrate content and increase the dietary fiber content of the bread product without deleteriously affecting the organoleptic qualities of the flour tortilla composition.

12. The flour tortilla composition of claim 11, including:
a resultant flour content defined as including about 15% by weight white tortilla flour, 15% vital wheat gluten, 65% amylase resistant starch, and 5% wheat protein isolate.

13. In an angel food cake composition having conventional wheat flour, the improvement comprising:
substituting a portion of the conventional wheat flour with a resistant starch in combination with a material selected from the group consisting of a wheat protein isolate a wheat protein concentrate, a devitalized wheat gluten product; a fractionated wheat protein; a deamidated wheat gluten, a hydrolyzed wheat protein product, and combinations thereof, in effective amounts to reduce the available carbohydrate content and increase the dietary fiber content of the bread product without deleteriously affecting the organoleptic qualities of the angel food cake composition.

14. The angel food cake composition of claim 13 including:
a resultant flour content defined as including a mixture of the resistant starch and gluten.

15. The angel food cake composition of claim 13, wherein the mixture has an 88:12 ratio of arnylase resistant starch to gluten.

16. In a white or yellow cake composition having conventional wheat flour, the improvement comprising:
substituting a portion of the conventional wheat flour with an amylase resistant starch in combination with a material selected from the group consisting of a wheat protein isolate a wheat protein concentrate, a devitalized wheat gluten product; a fractionated wheat protein; a deamidated wheat gluten, a hydrolyzed wheat protein product, and combinations thereof, in effective amounts to reduce the available carbohydrate content and increase the dietary fiber content of the bread product without deleteriously affecting the organoleptic qualities of the cake composition.

17. The cake composition of claim 16, including:
a resultant flour content defined as including a mixture of the amylase resistant starch and gluten.

18. The cake composition of claim 16, including:
a resultant flour content defined as consisting of a mixture of the amylase resistant starch and gluten.

19. In a pancake composition having conventional wheat flour, the improvement comprising:
substituting a portion of the conventional wheat flour with an amylase resistant starch in combination with a material selected from the group consisting of a wheat protein isolate a wheat protein concentrate, a devitalized wheat gluten product; a fractionated wheat protein; a deamidated wheat gluten, a hydrolyzed wheat protein product, and combinations thereof, in effective amounts to reduce the available carbohydrate content and increase the dietary fiber content of the bread product without deleteriously affecting the organoleptic qualities of the pancake composition.

20. The pancake composition of claim 19, including:
a resultant flour content defined as including a mixture of the amylase resistant starch and gluten.

21. The pancake composition of claim 19, including:
a flour content defined as consisting of a mixture of the amylase resistant starch and gluten.

22. In a fruity crunch bar composition having conventional wheat flour, the improvement comprising:
substituting a portion of the conventional wheat flour with an amylase resistant starch in combination with a material selected from the group consisting of a wheat protein isolate a wheat protein concentrate, a devitalized wheat gluten product; a fractionated wheat protein; a deamidated wheat gluten, a hydrolyzed wheat protein product, and combinations thereof, in effective amounts to reduce the available carbohydrate content and increase the dietary fiber content of the bread product without deleteriously affecting the organoleptic qualities of the fruity crunch bar composition.

23. The fruity crunch bar composition of claim 22, including:
a resultant flour content defined as including a mixture of the amylase resistant starch and hydrolyzed wheat protein.

24. The fruity crunch bar composition of claim 22, including:
a resultant flour content defined as consisting of a mixture of the amylase resistant starch and hydrolyzed wheat protein.

25. In a cookie composition having conventional wheat flour, the improvement comprising:
substituting a portion of the conventional wheat flour with an amylase resistant starch in combination with a material selected from the group consisting of a wheat protein isolate a wheat protein concentrate, a devitalized wheat gluten product; a fractionated wheat protein; a deamidated wheat gluten, a hydrolyzed wheat protein product, and combinations thereof, in effective amounts to reduce the available carbohydrate content and increase the dietary fiber content of the bread product without deleteriously affecting the organoleptic qualities of the cookie composition.

26. The cookie composition of claim 25, including:
a resultant flour content defined as including a mixture of the amylase resistant starch, hydrolyzed wheat protein, and wheat gluten.

27. In a brownie composition having conventional wheat flour, the improvement comprising:
substituting a portion of the conventional wheat flour with an amylase resistant starch in combination with a material selected from the group consisting of a wheat protein isolate a wheat protein concentrate, a devitalized wheat gluten product; a fractionated wheat protein; a deamidated wheat gluten, a hydrolyzed wheat protein product, and combinations thereof, in effective amounts to reduce the available carbohydrate content and increase the dietary fiber content of the bread product without deleteriously affecting the organoleptic qualities of the brownie composition.

28. The brownie composition of claim 27, including:
a resultant flour content defined as including a mixture of the amylase resistant starch, wheat protein isolate, and wheat gluten.

29. In a snack pellet composition having conventional wheat flour, the improvement comprising:
substituting a portion of the conventional wheat flour with an amylase resistant starch to increase the dietary fiber content of the bread product without deleteriously affecting the organoleptic qualities of the snack pellet composition.

30. The snack pellet composition of claim 29, wherein the amount of amylase resistant starch ranges from 10% to 25% by weight of the composition.

31. In an extruded breakfast cereal composition having conventional wheat flour, the improvement comprising:
substituting a portion of the conventional wheat flour with an amylase resistant starch to increase the dietary fiber content of the bread product without deleteriously affecting the organoleptic qualities of the extruded breakfast cereal composition.

32. The snack pellet composition of claim 3129, wherein the amount of amylase resistant starch ranges from 10% to 30% by weight of the composition.

33. In a corn curl composition having conventional wheat flour, the improvement comprising:
substituting a portion of the conventional wheat flour with an amylase resistant starch to increase the dietary fiber content of the bread product without deleteriously affecting the organoleptic qualities of the corn curl composition.

34. The corn curl composition of claim 33, wherein the amount of amylase resistant starch ranges from 25% to 75% by weight of the composition.

35. In a snack cracker formulation that contains conventional wheat flour, the improvement comprising:
substituting from 2% to 35% of the conventional flour with an amylase resistant starch.

36. In a chocolate chip cookie formulation that contains conventional wheat flour, the improvement comprising:
substituting the wheat flour with an amount ranging from 25% to 100% by weight of the conventional flour as an amylase resistant starch.

37. The chocolate chip cookie formulation of claim 36, wherein the substitution amount of amylase resistant starch is about 25%.

38. The chocolate chip cookie formulation of claim 36, wherein the substitution amount of amylase resistant starch is about 50%.

39. The chocolate chip cookie formulation of claim 36, wherein the substitution amount of amylase resistant starch is about 75%.

40. The chocolate chip cookie formulation of claim 36, wherein the substitution amount of amylase resistant starch is about 100%.

41. In a muffin formulation that contains conventional wheat flour, the improvement comprising:
substituting the wheat flour with an amount ranging from 25% to 75% by weight of the conventional flour as an amylase resistant starch.

42. The muffin formulation of claim 41, wherein the substitution amount of amylase resistant starch is about 25%.

43. The muffin formulation of claim 41, wherein the substitution amount of amylase resistant starch is about 50%.

44. The muffin formulation of claim 41, wherein the substitution amount of amylase resistant starch is about 100%.

45. In a brownie formulation that contains conventional wheat flour, the improvement comprising:
substituting the wheat flour with an amount ranging from 25% to 75% by weight of the conventional flour as an amylase resistant starch.

46. The brownie formulation of claim 45, wherein the substitution amount of amylase resistant starch is about 25%.

47. The brownie formulation of claim 45, wherein the substitution amount of amylase resistant starch is about 50%.

50. In a muffin composition having conventional wheat flour, the improvement comprising:
substituting a portion of the conventional wheat flour with an amylase resistant starch in combination with a material selected from the group consisting of a wheat protein isolate a wheat protein concentrate, a devitalized wheat gluten product; a fractionated wheat protein; a deamidated wheat gluten, a hydrolyzed wheat protein product, and combinations thereof, in effective amounts to reduce the available carbohydrate content and increase the dietary fiber content of the bread product without deleteriously affecting the organoleptic qualities of the muffin composition.

51. The muffin composition of claim 4950, including:
a resultant flour content defined as including about a mixture of amylase resistant starch and gluten.
